(19) United States
(12) Patent Application Publication
(10) Pub. No.: US 2024/0281294 A1
(43) Pub. Date: Aug. 22, 2024

(54) APPARATUS, METHOD, NON-TRANSITORY COMPUTER-READABLE MEDIUM AND SYSTEM

(71) Applicant: Intel Corporation, Santa Clara, CA (US)

(72) Inventor: Jeroen LEIJTEN, Hulsel (NL)

(21) Appl. No.: 18/498,101

(22) Filed: Oct. 31, 2023

(51) Int. Cl. G06F 9/50; G06F 13/16

(52) U.S. Cl. CPC G06F 9/5038; G06F 9/5016; G06F 13/1673

(57) ABSTRACT

It is provided an apparatus comprising interface circuitry, machine-readable instructions, and processing circuitry to execute the machine-readable instructions to: Control a processing circuitry of a computational system including a plurality of processing circuitries to determine if a number of input data token or tokens is available at one or more input buffers of a memory space; and control the processing circuitry to determine if at least a portion of the memory space for a number of output data token or tokens is available at one or more output buffers assigned to the processing circuitry; and control the processing circuitry to execute an iteration of a first task of an application, the application being modelled by a model, if it is determined that the number of input data token or tokens and memory space for the number of output data token or tokens are available.

### BACKGROUND

A computational system including multiple processing circuitries, for example multiple cores (also referred to as multicore-system), may integrate multiple processing circuitries into a single system or a single chip to for example optimize performance and energy efficiency. These computational systems are for example used in modern electronics, from smartphones to servers, as they allow multiple tasks to run simultaneously or a single task to be split and processed faster through parallel execution. By handling multiple operations concurrently, multicore computational systems may achieve greater throughput and handle complex computational tasks more efficiently. However, when executing distributed applications on such systems, challenges arise. Properly partitioning and scheduling tasks to efficiently utilize all cores, managing shared resources like memory, and handling inter-processing-circuitry communication may introduce complexities.

### BRIEF DESCRIPTION OF THE FIGURES

Some examples of apparatuses and/or methods will be described in the following by way of example only, and with reference to the accompanying figures, in which

FIG. 1a illustrates a block diagram of an example of an apparatus or device communicatively coupled to a computational system;

FIG. 1b illustrates a block diagram of an example of the computational system comprising the apparatus or device;

FIG. 2 illustrates a processor type;

FIG. 3 illustrates a model modelling a computational system for distributed computation of tasks of an application;

FIG. 4 illustrates a model modelling a computational system for distributed computation of tasks of an application;

FIG. 5 illustrates a flowchart of an example of a method;

FIG. 6a illustrates a block diagram of an example of an apparatus or device communicatively coupled to a computational system;

FIG. 6b illustrates a block diagram of an example of the computational system comprising the apparatus or device;

FIG. 7 illustrates a model modelling an application comprising a plurality of task;

FIG. 8 illustrates a buffer in a processer type of the model;

FIG. 9 illustrates a token representing a generalized data exchange format.;

FIG. 10 illustrates the token stored in the buffer;

FIG. 11 illustrates a buffer structure;

FIG. 12; illustrates a buffer with different regions allocated in different memories;

FIG. 13 illustrates the relation between an arc in an SDF model of an application a token format/buffer structure and a processor type of a processing circuitry;

FIG. 14a illustrates tracking tokens on an arc in a full state using indicators and deriving token position using indices;

FIG. 14b illustrates tracking tokens on an arc in an empty state using indicators and deriving token position using indices; and

FIG. 15 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

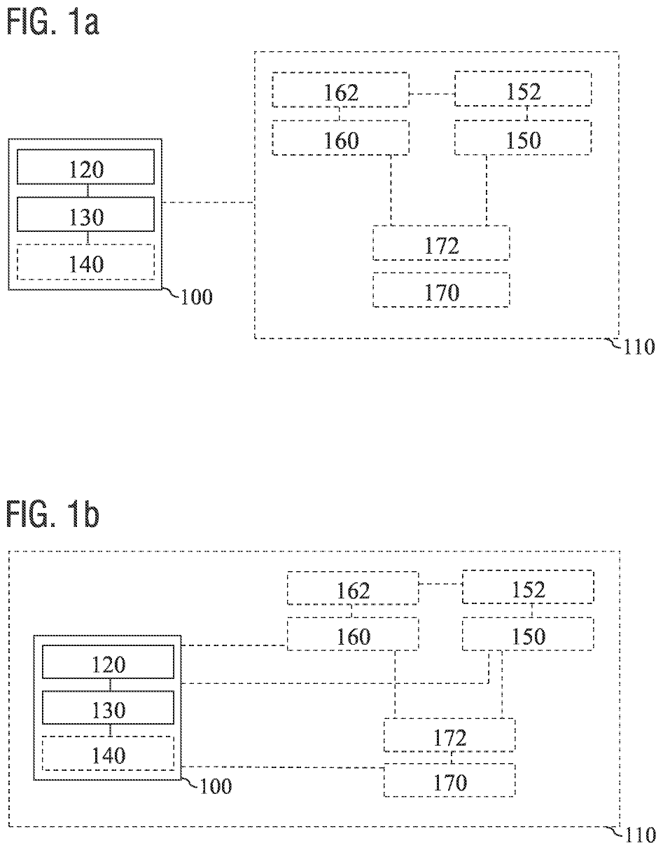

FIG. 1a illustrates a block diagram of an example of an apparatus 100 or device 100 communicatively coupled to a computational system 110. FIG. 1b illustrates a block diagram of an example of the computational system 110 comprising the apparatus 100 or device 100.

The apparatus 100 comprises circuitry that is configured to provide the functionality of the apparatus 100. For example, the apparatus 100 of FIGS. 1a and 1b comprises interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the computational system 110) and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

The processing circuitry 130 is configured to generate a model which is modelling a computational system for distributed computation of tasks of an application, the model comprising one or more processor types (also referred to as processor type instances).

The computational system 110 comprises a plurality of processing circuitries 150, 160, 170, physical memory 152, 162, 172 and a respective memory address space, and one or more interconnects for communication between the plurality of processing circuitries 150, 160, 170 and physical memory components 152, 162 172. The interconnects may connect some or all component (e.g., processing circuitry, physical memory) within the computational system 110 to some or all other components within the computational system 110. Further, the interconnects may connect some or all components within the computational system to the apparatus 100, for example to the interface circuitry 120. In another example the computational system 110 comprises more or less processing circuitries than illustrated in FIGS. 1a and 1b. The physical memory of the computational system 110 may comprise the physical memory components 152, 162 172 or more or less separate physical memory components than illustrated in FIGS. 1a and 1b. For example, the computational system 110 may comprise one physical memory component that is accessible via the interconnects by all processing circuitries of the computational system 110.

The (abstract programming) model is modelling the (physical) computational system 110 in a simplified, high-level (abstracted) representation designed of the computational system 110 to capture the essential features and behaviors of the computational system 110. The computational system 110 may carry out a distributed computation of tasks of an application. For example, the computational system 110 may execute an application (i.e., a software program or a set of related software programs). The application may comprise one or more sub-processes (i.e., tasks) that can be executed independently. Distributed computation of the tasks may refer to the process of distributing the tasks of the application across multiple processing units of the computational system 110, possibly located in different physical locations, to be executed concurrently or in a coordinated manner to achieve the application's objectives more efficiently. For example, the model may capture three features of the computational system 110 when carrying out the tasks of the application, that is computing, storing (i.e., writing/reading) and communicating.

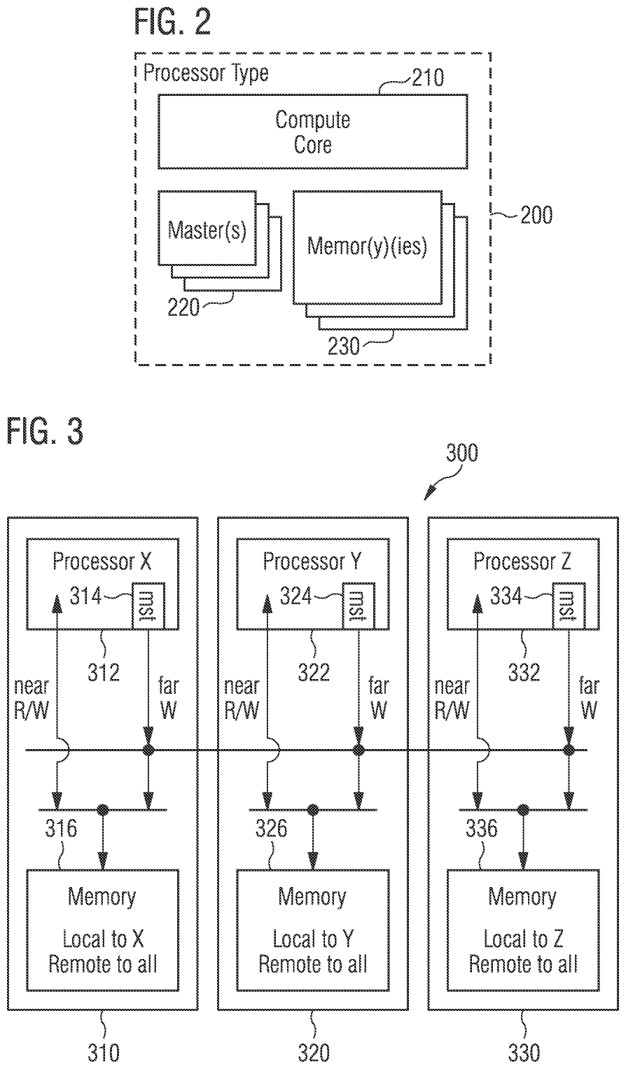

The model represents the physical computational system 110 as a one or more processor types (see also FIGS. 2-4). Each processor type comprises a processing circuitry identifier which corresponds to a respective specific processing circuitry. Further, the processor type comprises one or more master interfaces identifiers which corresponds to one or more physical interfaces of the processing circuitry. Further, the processor type comprises one or more memory identifiers which corresponds to one or more physical memory spaces and/or corresponding one or more respective address space regions.

FIG. 2 illustrates a processor type 200. The processor type 200 comprises a processing circuitry identifier 210 (also referred to as specific Instruction Set Architecture (ISA)) and a respective specific processing circuitry (also referred to as compute core). Further, the processor type 200 comprises zero or more master interfaces identifiers 220. Further, the processor type 200 comprises zero or more memory identifiers 230 with at least one master or one memory present. In a process type model, each of the compute cores, master interfaces, and memories is specified using a unique identifier.

### Processing Circuitry

The processor type includes a processing circuitry identifier, a memory identifier, and an interface identifier. The processing circuitry 130 is configured to generate a first processor type which comprises providing a first processing circuitry identifier for a first processing circuitry 150 (or 160 or 170).

The plurality of processing circuitries 150, 160, 170 of the computational system 110 may comprise at least one of a central processing circuitry (CPU), micro-controller, graphical processing circuitry, (GPU), digital signal processor (DSP), application-specific instruction-set processor (ASIP), accelerator, fixed function hardware, direct memory access, (DMA), engine or I/O device or the like.

A first task of the application may be compiled on to the first processor type (also referred to as processor type instance). That is the first task may be carried out by the first processing circuitry 150 which corresponds to the first processor type. The processing circuitry 130 may be further configured to generate for each task of the application a processor type with a corresponding processing circuitry to carry out the task.

### Physical Memory and Address Space

The processing circuitry 130 is configured to generate a first processor type which further comprises providing a first memory identifier for a first address space region of the address space. The first address space region is an address space from which input data is read by the first processing circuitry 150 during task execution.

A memory identifier in the model may identify an address space region of the address space that is a target of data transfer. For example, the data transfer may be performed using memory-mapped I/O (MMIO), covering a certain area of the system address space.

MMIO is a technique for extending the address space's utility to the realm of input/output (I/O) device interactions. That is the address space of a computational system is not only built on the physical memory of the system but also in the memory provided by the I/O devices. In MMIO, certain address ranges within the memory address space are mapped to I/O devices, allowing the processor to communicate with these devices using the same instructions and mechanisms it uses for memory access. Each I/O device is assigned a unique range of addresses within this mapped space, and accessing these addresses corresponds to reading from or writing to the respective devices. This unified approach simplifies the system architecture and programming model, by harmonizing the mechanisms for memory and I/O operations within the same memory address space, thus fostering a cohesive and efficient method for the processor to interact with the broader system's components.

The output data (also referred to as data) of the first processing circuitry 150 may be written to the physical memory 152/162/172 for the second address space region of the address space via memory mapped I/O. Therefore, the physical memory may be located anywhere inside or outside the computational system 110 and may still be accessed as part of the address space of the computational system 110. Therefore, the address space region identified by a memory identifier may correspond to physical memory 152/162/172 that may comprise at least one of the static random access memory, SRAM, dynamic random access memory, DRAM, a hardware buffer (such as a FIFO), a register bank located at a specific memory-mapped address in the system, or a memory-mapped output port of the system. Therefore, any type of compute or data transfer device can be modelled as an address space region identified by a memory identifier which is part of a processor type of the model.

The memory address space corresponding to the physical memory may define a part or all of addressable locations through which a computer or processor can access and manipulate data stored in the physical memory. Each unique address within memory address space maps to a specific location in the physical memory, facilitating data retrieval or storage. The memory address space, defined by the system's architecture, can encompass multiple separate physical memory components, such as different memory modules, chips, or a combination of RAM and disk storage or the like. Therefore, despite possible separate physical memory components, the memory address space appears logically contiguous to the processor or operating system. Through address translation mechanisms like Memory Management Units (MMUs) or virtual memory systems or the like, logical or virtual addresses generated by programs may be mapped to the correct physical addresses across these possible various physical memory components. This setup may enable efficient and flexible memory management and also abstracts the complexity of the underlying physical memory architecture, allowing for standardized memory access at the logical level.

The first processing circuitry 150 may be writing to an address space region of the address space reachable by the first interface.

The first memory identifier defines from which addressable areas in the physical memory, the input data to be processed by tasks may be located. This technique in the model implies that the first processing circuitry 150 reads task input data from memories 152/162/172 defined as being part of the first processor type which comprises the first processing circuitry. Further, in the model, a task output data (also referred to as data) is written via master interfaces that are part of the first processing circuitry 150 in the first processor type.

Further, the address space regions of the address space identified by different memory identifiers may be classified into local and remote memory identifiers/address space regions. From the viewpoint of a processing circuitry, address space regions/memory identifiers may be separated into two groups: First address space regions/memory identifiers that are local (near) to a given processing circuitry and second address space regions/memory identifiers that are remote (far) to a given processor. This classification may be logical.

For example, the physical memory 152/162/172 that is corresponding to the address space regions/memory identifiers that are classified as being local to a processing circuitry may be physically situated close to that processing circuitry in the computational system. For example, local address space regions/memory identifiers for a given processing circuitry may be chosen such that access to those address space regions from the processing circuitry provides low latency and high bandwidth to the processing circuitry. Local address space regions/memory identifiers may be closely coupled to the processing circuitry. Local address space regions are defined as memory identifiers that are part of a processor type which the processing circuitry, they are local to, is also part of. Remote address space regions are then any address space regions reachable by the processing circuitry through one of its (master) interfaces. This may include other reachable address space regions in the system but may also include some or all of the local address space regions of the processing circuitry itself (see also FIG. 3), provided these are reachable by the (master) interface of the processor. In another example, the physical memory 152/162/172 that is corresponding to the address space regions/memory identifiers that are classified as being local to a processing circuitry may be physically situated farer away to that processing circuitry in the computational system. In another example, as also illustrated in FIG. 3, the memories corresponding to a memory identifier being part of a processor type, may still be used for intra-task read/writes, i.e., as a tasks “scratchpad” memory.

In another example, buffer space may be allocated for all buffer regions in all relevant instances of memories identified by a memory identifier corresponding to a processor type in the computational system, as well as configuring the control management for such buffer (e.g., get/put indicators as described below).

FIG. 3 illustrates a model 300 modelling a computational system for distributed computation of tasks of an application. FIG. 3 shows the model 300 modelling a computational system (for example the computational system 110) for distributed computation of tasks of an application. The model 300 comprises three processor types, 310, 320, 330. The model 300 comprises a first processor type 310 which comprises a first processing circuitry identifier 312 for the first processing circuitry X. Further, the first processor type 310 comprises a first memory identifier 316 for the first memory space region. Further, the first processor type 310 comprises a first interface identifier 314 for the interface mst through which output data (also referred to as data) of the first processing circuitry X (150) is written to the first 310 second 320 and third 330 address space regions of the address space. The model 300 comprises a second processor type 320 which comprises a second processing circuitry identifier 322 for the second processing circuitry Y (160). Further, the second processor type 320 comprises a second memory identifier 326 for the second memory space region. Further, the second processor type 320 comprises a second interface identifier 324 for the interface mst through which output data of the second processing circuitry is written to the first 310 second 320 and third 330 address space regions of the address space. The model 300 further comprises a third processor type 330 which comprises a third processing circuitry identifier 332 for the third processing circuitry Z (170). Further, the third processor type 330 comprises a third memory identifier 336 for the third memory space region. Further, the third processor type 330 comprises a third interface identifier 334 for the interface mst through which output data of the third processing circuitry is written to the first 310 second 320 and third 330 address space regions of the address space. As described above the first memory space 310 is local/near to processor X and far to processor Y and Z. Respectively, the second memory space 320 is local/near to processor Y and far to processor X and Z. Respectively, the third memory space 330 is local/near to processor Z and far to processor X and Y. FIG. 3 illustrates a local vs. remote memory and near vs. far memory access. In other words, FIG. 3 illustrates a local vs. remote memory and near vs. far memory access.

Any access to a local memory by a given processor X/Y/Z may be defined as near memory access, whereas any access to a remote memory is defined as far memory access. To ensure a high read/write efficiency with low latency, a high throughput, and low buffer requirements, the model 300 assumes that a task running on a given processor X/Y/Z consumes its input from local memory and produces its outputs in remote memory. This may imply that communicating tasks will always read from near memories and write to far memories. Writing to a far memory may refer to a producing task writing its results directly into the local memory of the processor on which the task that shall consume those results is running.

In another example, writing to far memory may further be assumed to imply writing exclusively using non-posted writes (i.e., “fire and forget”) to ensure high write performance latency although. However, computational systems that use posted writes may also be modeled by the model as described above.

### Interconnects for Communication and Interfaces

The processing circuitry 130 is configured to generate a first processor type which further comprises providing a first interface identifier for an interface of the first processing circuitry 150. Through the interface of the first processing circuitry 150, identified by the first interface identifier, the data (also referred to as output data) of the first processing circuitry 150 is written to a second address space region of the address space.

The first interface identifier may be an initiator of data transfer of the first processing circuitry 150 to the second address space region of the address space using memory-mapped I/O. That is the (master) identifiers may define via which processor interfaces output data may be written to the system. A (master) interface in a processor type of the abstract model is defined as an initiator of data transfer. For example, the interface may initiate data transfer using memory-mapped I/O. Therefore, the interface may correspond to many kinds of data initiator interfaces and protocols. Therefore, the interconnects for communication between the plurality of processing circuitries 150, 160, 170 and the physical memory 152, 162, 172 may comprise hardware components and software components like a communication protocol. The interconnects for communication between the plurality of processing circuitries 150, 160, 170 and the physical memory 152, 162, 172 comprises at least one of a hierarchy of buses, Networks-on-Chip, point-to-point connection or ring fabric or the like.

Therefore, the one or more interconnects for communication between the plurality of processing circuitries and the physical memory can be abstracted by assuming a path from a memory identifier of a first processing circuitry 150 (source) to a memory identifier of second processing circuitry (destination). This path may be unambiguously expressed via a source-to-destination address map. In one example that address map is unique for each source in the computational system. In another example that address map is not unique for each source in the computational system. The one or more interconnects for communication between the plurality of processing circuitries and the physical memory in the computational system are thus represented in the model as described above, such that any interconnect hierarchy, topology, or protocol is modelled as the routing of data from a first processing circuitry master interface identifier (acting as source) to a second processing circuitry memory identifier (acting as destination). The routing path from source to destination may be selected based on a single memory-mapped address (which may or may not be composed of different address fields with specific meaning, e.g., a destination processor ID, a destination processor memory sub ID and an in-memory address offset). In other words, the abstracted representation of the one or more interconnects for communication between the plurality of processing circuitries and the physical memory in the model defines for each master interface in the computational system, which address space region (identified by a memory identifier) in the computational system can be accessed seen from the master interface (identified by the interface identifier).

For example, the processing circuitry 130 may generate for the first interface identifier one or more interconnect identifiers for the interconnects for communication through which output data (also referred to as data) is written from the interface of the first processing circuitry 150 to address space regions for one or more memory identifiers in one or more processor types for one or more processing circuitries 150, 160, 170 of the computational system.

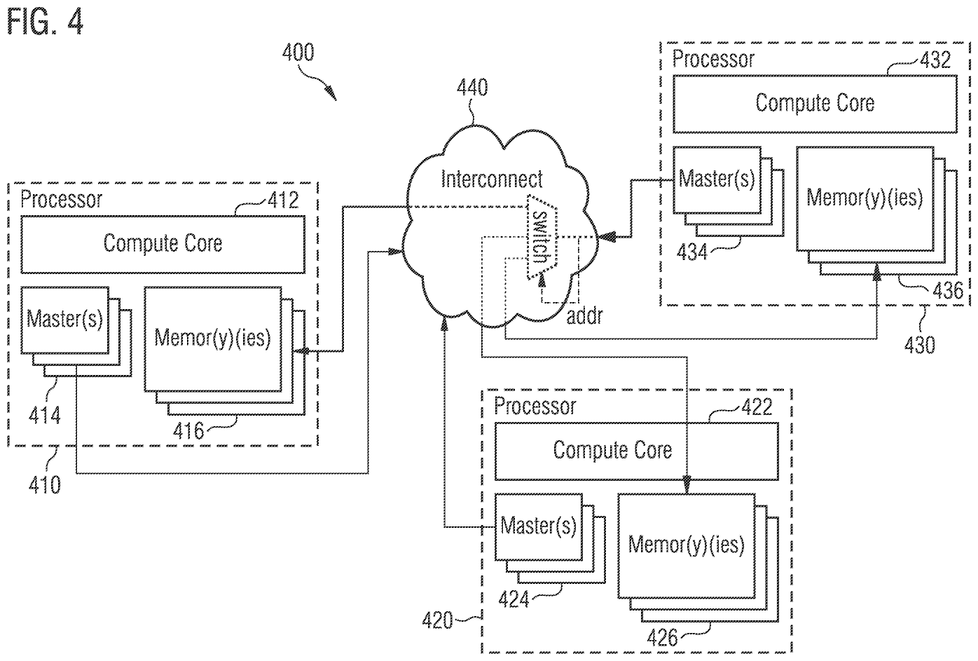

Further, for example the processing circuitry 130 generates a second processor type comprising a second processing circuitry identifier for a second processing circuitry 160 of the plurality of processing circuitries. The processing circuitry 130 generates a second memory identifier for the second address space region of the address space. The second address space region being an address space from which input data is read by the second processing circuitry 160 during task execution (see for example FIG. 4 where the model of the computational system comprises three processor types).

FIG. 4 illustrates a model 400 modelling a computational system for distributed computation of tasks of an application. FIG. 4 shows the model 400 modelling a computational system (for example the computational system 110) for distributed computation of tasks of an application. The model 400 comprising three processor types, 410, 420, 430. The model 400 comprises a first processor type 410 which comprises a first processing circuitry identifier 412 for the first processing circuitry. Further, the first processor type 410 comprises a first memory identifier 416 for the first memory space region. Further, the first processor type 410 comprises a first interface identifier 414 for the interface through which output data of the first processing circuitry is written. The interface (identified by the first interface identifier) can access a second and third address space region (identified by the memory identifiers 426 and 436). Each interconnect between the first processing circuitry and the second and third processing circuitry may be represented by an address map between the first interface identifier 414 and the second 426 or third 436 memory identifier. Further, the model 400 comprises a second processor type 420 which comprises a second processing circuitry identifier 422 for the second processing circuitry. Further, the second processor type 420 comprises a second memory identifier 426 for the second memory space region. Further, the second processor type 420 comprises a second interface identifier 424 for the interface through which output data of the second processing circuitry is written. The interface (identified by the second interface identifier) can access a first and third address space region (identified by the memory identifiers 416 and 436). Each interconnect between the second processing circuitry and the first and third processing circuitry may be represented by an address map between the second interface identifier 424 and the first 416 or third 436 memory identifier. Further, the model 400 comprises a third processor type 430 which comprises a third processing circuitry identifier 432 for the third processing circuitry. Further, the third processor type 430 comprises a third memory identifier 436 for the third memory space region. Further, the third processor type 430 comprises a third interface identifier 434 for the interface through which output data of the third processing circuitry is written. The interface (identified by the third interface identifier) can access a first and second address space region (identified by the memory identifiers 416 and 426). Each interconnect between the third processing circuitry and the first and second processing circuitry may be represented by an address map between the third interface identifier 434 and the first 416 or second 426 memory identifier. The interconnect 440 is implemented by the address mappings between each of the interface identifiers and each of the memory identifiers.

### Modelling a Computational System for Distributed Computation of a Task

For example, processing circuitry 130 is configured to generate a task interface data structure for a first task of the application. A task interface structure may be a data structure, that defines which specific hardware of the computational system 110 is used to carry out a specific task of the application and by which by processor type and corresponding identifiers this hardware is identified. Generating the task interface data structure for a first task comprises determining a processing circuitry identifier for a processing circuitry of the plurality of processing circuitries 150/160/170 which executes the task. Generating the task interface data structure for a first task comprises determining a memory identifier for an address space region of the address space to store input data received by input ports of the first task which is read by the determined processing circuitry 150 during execution of the first task. Generating the task interface data structure for a first task comprises determining an interface identifier for an interface of the determined processing circuitry 150 through which output data (also referred to as data) of the output ports of the first task executed by the determined processing circuitry 150 is written to an address space region of the address space.

Further, an application may be modelled as a model (for example a data flow graph (DFG) (for example a synchronous data flow (SDF), see details below). The above described model modelling the computational system 110 for distributed computation of tasks of an application as described above may then be used in a task programming API together with a DFG model (see below). It may be used together with task software compilers to compile code onto a given processing circuitry modelled by a specific processor type of the model. Further, together with a system address map as described above, the model of the computational system as described above may provide all information required to setup communication paths from master interfaces (identified by interface identifiers) of processing circuitries to address spaces (identified by memory identifiers) of processing circuitries for all arcs in an application graph of a DFG The latter may be hidden from the application programmer by hiding it under an API that allows the specification of application graphs, the assignment of tasks in those graphs to processor types, and an automatic derivation and configuration of communication paths for all arcs in the graph consistent with the processing circuitry assignments made for all tasks in the graph.

The above described technique includes an abstraction and generalization of interfacing for communication and storage in a computational system including a plurality of processing circuitry (for example a heterogenous multi-processor systems, composed of processing circuitries ranging from fully programmable to fixed-function hardware, integrated with any type of interconnect infrastructure). For example, the above described technique may be utilized as a programming model for a heterogeneous multi-processor system on chip (SoC) for digital signal processing. The above described technique enables implementing an efficient, generic, abstract programming via an Application Programming Interface (API) for application/system configuration, task communication, and task synchronization. An API is a set of protocols that allows different software applications to communicate with each other. An API defines the methods and data structures that developers can use to request and exchange information between systems or components. This may eliminate the need for low-level primitive programming by a programmer to implement among others buffer allocation, data storage, data communication, and task scheduling and the like.

The above described technique provides case-of-use and efficiency, and drastically reduces complexity in programming real-time radio workloads targeting a computational system. Further, the above described technique provides generalization and abstraction of the various types of processing circuitries and accelerators in the computational system and enables generic programming APIs to support rapid development of robust, modular, and scalable programmable signal processing applications on heterogeneous hardware. The above described technique is generically applicable to different computational systems for example to (heterogeneous) multi-core system targeting digital signal processing applications (e.g., communications, imaging, video, military, AI). For example, the computational system may be composed of a 2D-mesh array of multiple (for example 40 or the like) Single Instruction, Multiple Data (SIMD)/Very Long Instruction Word (VLIW) cores, several micro-controllers, various types of fixed function hardware, such as hardware acceleration, and/or I/O peripherals. Further, the above described technique may be used with regards to dense compute solutions based on multiple (for example hundreds) of vector engines integrated into modern FPGAs.

The above described technique enables that tasks of an application targeting instances of a specific processing circuitry may be implemented in isolation form other task and without any knowledge of the context of the computational system in which they are embedded. That is, a task developer does not require knowledge about the producer of input data for the task, nor about the consumer of output data of the task, let alone how and on which kinds of processing circuitry these producers and consumers are implemented.

The above describe technique enables a computational system (for example a multi-core system like a SoC) to be operated (for example when executing distributed tasks of an application) faster, with less system failures more efficiently and with less power consumption.

For example, the above described technique may relate to a programming model and corresponding API(s) that may be described in a programmer's manual or cookbook, related training material, and code examples.

Below an example of an algorithm (in C preprocessor macro syntax) is given, for generating a processor type (also referred to as processor type instance) of a model which is modelling a computational system as described above (the text following the “//” is commenting the corresponding line of code):

```
SDF_PROCESSOR_TYPE( // processor type declaration
compute_engine, // compute core / ISA identifier, known to underlying SysRT
SDF_MEMORIES( // local memory identifier list, known to SysRT
  SYSRT_ID_compute_engine_coreio_sdlm, // scalar data memory
  SYSRT_ID_compute_engine_coreio_vdlm // vector data memory
),
SDF_MASTERS( // master list, known to SysRT
  SYSRT_ID_compute_engine_coreio_smdlm, // scalar data master
  SYSRT_ID_compute_engine_coreio_vmdlm // vector data master
),
// memory used for SDF administration
SDF_ADMIN_MEM(SYSRT_ID_compute_engine_coreio_sdlm), // scalar data
memory
// master used for SDF administration
SDF_ADMIN_MST(SYSRT_ID_compute_engine_coreio_smdlm) // scalar data
master
);
```

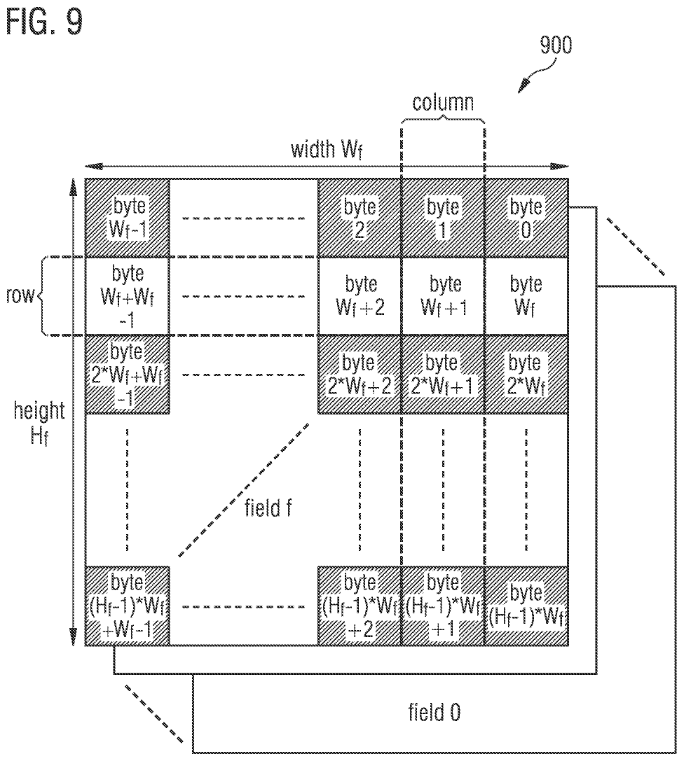

The above code shows the specification of a processor type comprising a processing circuitry identifier called “compute_engine”, two memory identifiers called “SYSRT_ID_compute_engine_coreio_sdlm” and “SYSRT_ID_compute_engine_coreio_vdlm” and two interface identifiers called “SYSRT_ID_compute_engine_coreio_smdlm, // scalar data master” and “SYSRT_ID_compute_engine_coreio_vmdlm”. The two memory identifiers are deemed local to the processing circuitry master interfaces that can be used. The identifiers “SDF_ADMIN_MEM” and “SDF_ADMIN_MST” in the code above may specify, a specific default address space region (memory) and a specific default master interface that may be assumed by the APIs for storing and communicating administrative information, which may include among other get/put indicators that maintain the state of arc buffers (see FIG. 9). Further, as described above, the reading near and writing far of data (i.e., token content) may apply for this control information as well.

The underlying System Run Time (“SysRT”) API may define unique identifiers for any processing circuitry (also referred to as compute core ISA), processing circuitry master interface and physical memory in the computational system. This SysRT API may provide the address map information required to connect from any uniquely identifiable master interface to any uniquely identifiable physical memory (address space region) in the computational system at run-time, provided the physical links to create such connections exist. For example, after specifying such identifiers in a processor type of a model of the computational system, a mode (for example (graph) API may be using such a specification any may thus obtain routing information to connect tasks of an application executed by the computational system mapped to processing circuitries in the computational system and represented by nodes in the application model (see SDF graph below).

The computational system 110 comprising a plurality of processing circuitries may be a multi-core system comprising a plurality of cores. A multicore system may feature a single physical processing unit (for example a CPU) that houses multiple processing cores, each capable of executing instructions independently.

The computational system 110 may be an SoC. An SoC integrates several computer components into a single chip to provide the functionalities of a complete or near-complete computer. An SoC may house a processor (or multiple processors), memory blocks, input/output interfaces, and often secondary storage and other peripheral functions on a single silicon chip. This integration contributes to significant space and power savings, making SoCs suitable for compact and mobile devices such as smartphones, tablets, and embedded systems.

The computational system 110 may be executing digital signal processing (DSP) applications. DSP is a technique used to manipulate signals after they have been converted from analog to digital form. It involves the use of mathematical algorithms to process, analyze, transform, or filter these digital signals to extract useful information, improve signal quality, or adapt to desired outputs. DSP is important in various fields such as telecommunications, audio processing, image and video processing, radar and sonar systems, and biomedical signal processing, among others. The DSP applications may be software defined radio, wireless communication, audio processing, image processing, video codecs, video processing, AI, military applications or the like.

Further, a computational system (for example the computational system 110) may comprise the apparatus (for example the apparatus 100) with circuitry configured to perform the technique as described above. The computational system may further comprise a plurality of processing circuitries (for example 150, 160, 170) comprising the first processing circuitry (for example 150). The computational system may further comprise the physical memory (for example 152, 162, 172) and the respective memory address space. The computational system may further comprise the one or more interconnects for communication between the plurality of processing circuitries and the physical memory. A processor type comprises the first processing circuitry identifier for the first processing circuitry, the first memory identifier for a first address space region of the address space and the first interface identifier for an interface of the first processing circuitry through which output data of the first processing circuitry is written to a second address space region.

Many applications, like DSP, may require programmable computational systems that are composed of multiple and potentially different types of programmable devices and processing circuitries (e.g., CPUs, DSPs, and ASIPs), weakly programmable or fully fixed-function accelerator devices, various I/O peripheral devices, and distributed memory devices. Such devices may be wired together using a variety of interconnect hierarchies based on different interconnect IPs using a multitude of communication and synchronization protocols. It may be a challenge to implement an application on such computational systems. It may be a challenge to program the communication between the various kinds and instances of processing circuitries, the synchronization thereof, the allocation and maintenance of buffers involved in such communication, and a scheduling of task execution on each device. A further challenge may be the need to achieve a high level of concurrency and utilization to ensure high performance efficiency, especially under real-time constraints.

Previous solutions typically rely on a programmer using low-level primitives for communication and synchronization. This may include primitives to allocate and manage communication buffers, deal with specific timing in synchronization, and setup and control the movement of data. In a heterogeneous multi-core system, the required low-level primitives will typically differ between different pairs of communicating devices. Hence, the programmer may have to use different techniques and different program code for the communication between different types of devices. A typical result is that significant “glue” is required to obtain matching interfaces between devices.

Previously scheduling and controlling task execution and synchronizing data exchange was done for example using central control processing circuitries in the computational system (e.g., a CPU or micro-controller) that may be used to trigger the execution of tasks of the application assigned to secondary processing devices (e.g., other CPUs, DSPs, ASIPs, hardwired accelerators). Thereby, a central processing circuitry may for example also need to control and synchronize DMA engines to ensure that data may arrive in the right buffer at the right time. The central processing circuitry/processing circuitries may have to keep track of the status of all secondary processing circuitries and potentially all buffers to ensure proper synchronization of tasks of the application and sufficient concurrency in processing. Therefore, central knowledge of all tasks of the application running in the computational system may be needed. Moreover, there may be a central notion of time and events in the computational system to properly synchronize the execution of tasks. These aspects may be highly complex, difficult to handle and challenging to program and debug. Further, the use of a central processing circuitry for scheduling, buffer management, and/or synchronization may complicate the overall computational system architecture. It may require additional costly hardware resources in the form of CPUs, micro-controllers, timers, interrupt controllers and/or additional interconnects. Central resources may become a performance bottleneck in an application, as they are shared resources for all task of the application. Further, hard-real-time constraints may arise when dealing with shared central resources. Proving that hard real-time constraints are met under all conditions may be difficult and may require over-dimensioning system resources to ensure safeguarding of the processing, which increases cost. Further, centralized control of the computational system may not be scalable, because of centralized resource bottlenecks.

Further, scheduling and synchronization was also previously performed for example without a central control processing circuitry for example based on the common technique of semaphores for synchronization (for example, two tasks running on two different processing circuitries). However, this was done based on using low-level primitives that may be different for different types of processing circuitries that may be used by a programmer to perform the synchronization and/or scheduling. Further, buffer allocation and management may be handled by the task programmer as well. Still further, in this case knowledge of the specific timing of events may still be required in communication and synchronization because no common framework that spans across different types of devices including accelerators and I/O peripherals is available. The use of low-level primitives in application software/firmware (SW/FW) may however be complex, error-prone, and obstructs reuse. This may lead to high development effort, and a high chance of late and complicated bugs. Without a programming model, protocol and corresponding APIs, a programmer may be focused on a given task of an application mapped to a given processing circuitry of the computational system and needs further to be aware of the behavior of surrounding tasks and surrounding processing circuitries to perform communication, buffer management, and synchronization. Further, the programmer may still have to be aware of the specific timing of events to ensure proper synchronization and meeting real-time constraints.

These previous approaches may suffer from the need for programmers to be aware of the overall computational system and all tasks of an application, even while developing only parts of that application. Further, a change in one seemingly independent task within the application may have immediate impact on other tasks in the application. In other words, the previous approaches to control a computational system executing distributed tasks of an application lack modularity and composability. Further, besides being complex and error-prone, the previous approaches and their lack of standardization and generalization of communication, buffering, scheduling, and synchronization mechanisms in the computational system leads to performance, power, and cost overheads due to additional effort SW/FW being required to enable communication and synchronization across mismatched interfaces caused by different low-level assumptions with respect to communication and synchronization primitives and protocols. Further, these drawbacks make it difficult to provide efficient and broadly applicable (hardware) acceleration for any of the communication and synchronization mechanisms.

These challenges and drawbacks are solved by the techniques as described above and below. For example, the techniques as described above and below are based, amongst others, on abstraction, formalization, generalization, standardization and modularization of the included devices, processing circuitries and processors. For example, the techniques as described above and below deliver a generic programming model and protocols which are supported and utilized by corresponding APIs. Such APIs may hide system complexity from programmers and enable those programmers to develop composable software/firmware modules that may be easily integrated into a complete application. Moreover, they may enable the development of specific hardware interfaces and acceleration features to efficiently implement multi-device execution, communication, and synchronization.

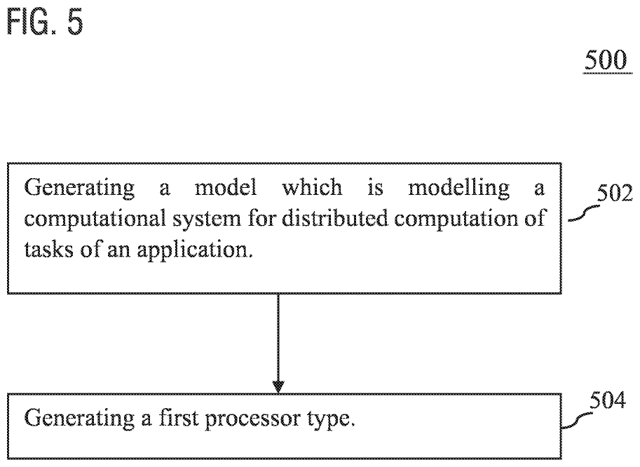

Summarizing the above, FIG. 5 further illustrates a flowchart of an example of a (e.g., computer-implemented) method 500. The method 500 comprises generating 502 a model which is modelling a computational system for distributed computation of tasks of an application. The model comprising one or more processor types. The computational system comprises a plurality of processing circuitries, physical memory and a respective memory address space, and one or more interconnects for communication between the plurality of processing circuitries and the physical memory. A processor type comprises a processing circuitry identifier, a memory identifier, and an interface identifier. The method 500 comprises generating 504 a first processor type which comprises: Generating 504a a first processing circuitry identifier for a first processing circuitry. Generating 504b a first memory identifier for a first address space region of the address space, the first address space region being an address space from which input data is read by the first processing circuitry during task execution. Generating 504c a first interface identifier for an interface of the first processing circuitry through which output data of the first processing circuitry is written to a second address space region.

More details and aspects of the method 500 are explained in connection with the proposed technique above and below or one or more examples described above or below. The method 500 may comprise one or more additional optional features corresponding to one or more aspects of the proposed technique, or one or more example described above.

### Modelling an Application

In the following an example of an application is described. For example, the application is modelled as a data flow graph (DFG. The DFG model of the application may be combined with the above described model modelling a computational system for distributed computation. Or the model of the application as a data flow graph (DFG) and the model modelling a computational system for distributed computation may be applied and used separately from each other.

For example, the application may be modelled as a data flow graph comprising one or more nodes each to represent a respective task of the application carried out by a respective processor type.

Further, the application described above may be modelled as an SDF graph comprising one or more nodes each to represent a respective task of the application carried out by a respective processor type.

Further, the SDF graph may further comprise connections (for example directed arcs) connecting input ports and output ports corresponding to input and output buffers of task carried out by respective nodes. Input buffers may hold data tokens which may be read by a task. Output buffers may hold data tokens which may be generated by a task. An input buffer may be located in a memory identifier corresponding to a reading processing circuitry.

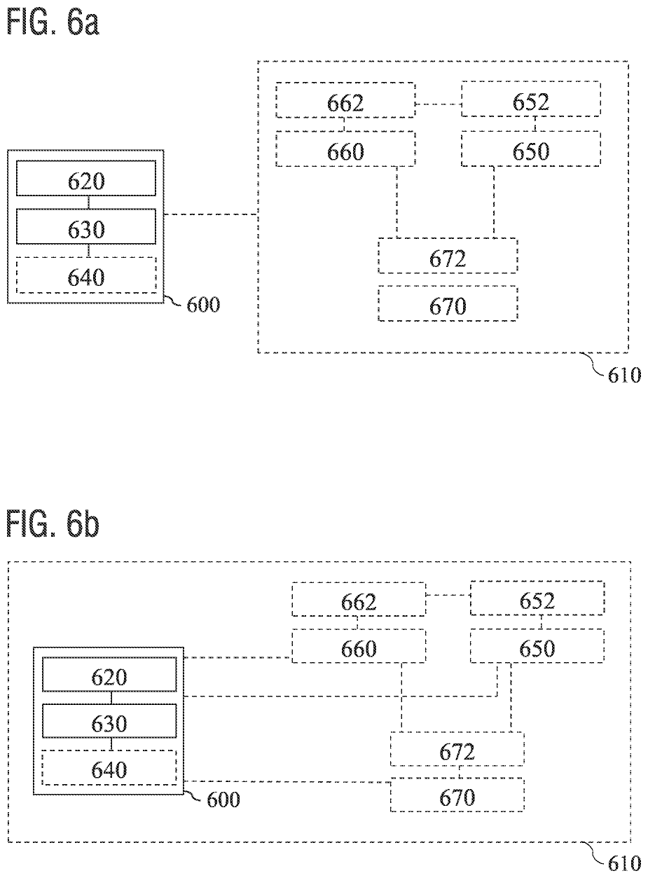

FIG. 6a illustrates a block diagram of an example of an apparatus 600 or device 600 communicatively coupled to a computational system 110. FIG. 6b illustrates a block diagram of an example of the computational system 610 comprising the apparatus 600 or device 600.

Apparatus 600 and computational system 610 and all the components included in the apparatus 600 and computational system 610 may be identical to apparatus 100 and computational system 110 respectively, as described with regards to FIGS. 1a and 1b. All processes and techniques as described above carried out by the apparatus 100 and/or the computational 110 and/or their circuitries, may also be carried out by the apparatus 600 and/or the computational 110 and/or their circuitries and vice versa. The respective techniques described with regards to FIGS. 6a and 6b may be carried out together or independently from the techniques described with regards to FIGS. 1a and 1b and vice versa.

The apparatus 600 comprises circuitry that is configured to provide the functionality of the apparatus 600. For example, the apparatus 600 of FIGS. 6a and 6b comprises interface circuitry 620, processing circuitry 630 and (optional) storage circuitry 640. For example, the processing circuitry 630 may be coupled with the interface circuitry 620 and with the storage circuitry 640.

For example, the processing circuitry 630 may be the same as the processing circuitry 650, or the processing circuitry 630 may be the same as the processing circuitry 660, or the processing circuitry 630 may be the same as the processing circuitry 672. Further, the interface circuitry 620 may be the same as the interface circuitry 652, or the interface circuitry 620 may be the same as the interface circuitry 662, or the interface circuitry 620 may be the same as the interface circuitry 672.

For example, the processing circuitry 630 may be configured to provide the functionality of the apparatus 600, in conjunction with the interface circuitry 620. For example, the interface circuitry 620 is configured to exchange information, e.g., with other components inside or outside the computational system 610) and the storage circuitry 640 (for storing information, such as machine-readable instructions).

Likewise, the device 600 may comprise means that is/are configured to provide the functionality of the device 600. The components of the device 600 are defined as component means, which may correspond to, or implemented by, the respective structural components of the apparatus 600. For example, the device 600 of FIGS. 6a and 6b comprises means for processing 630, which may correspond to or be implemented by the processing circuitry 630, means for communicating 120, which may correspond to or be implemented by the interface circuitry 620, and (optional) means for storing information 640, which may correspond to or be implemented by the storage circuitry 640.

In the following, the functionality of the device 600 is illustrated with respect to the apparatus 600. Features described in connection with the apparatus 600 may thus likewise be applied to the corresponding device 600. In general, the functionality of the processing circuitry 630 or means for processing 630 may be implemented by the processing circuitry 630 or means for processing 630 executing machine-readable instructions. Accordingly, any feature ascribed to the processing circuitry 630 or means for processing 630 may be defined by one or more instructions of a plurality of machine-readable instructions. The apparatus 600 or device 600 may comprise the machine-readable instructions, e.g., within the storage circuitry 640 or means for storing information 640.

The storage circuitry 640 (or means for storing information 640) may be implemented identical to the storage circuitry 140. The interface circuitry 620 (or means for communication 620) may be implemented identical to the interface circuitry 620. The processing circuitry 630 (or means for processing 630) may be implemented identical to the processing circuitry 630.

The processing circuitry 630 is configured to control a processing circuitry 650 of a computational system 610 comprising a plurality of processing circuitries 650, 660, 670 to determine if a number of input data token or tokens is available at one or more input buffers of a memory space. For example, the memory space being assigned to the processing circuitry 650. The processing circuitry 630 is configured to control the processing circuitry 650 to determine if at least a portion of the memory space for a number of output data (also referred to as data) tokens is available at one or more output buffers assigned to the processing circuitry. The processing circuitry 630 is configured to control the processing circuitry 650 to execute an iteration of a first task of an application if it is determined (for example by the processing circuitry 650 or by the processing circuitry 630) that the number of input data token or tokens and memory space for the number of output data token or tokens are available. The application is modelled by a model, for example a (data flow) graph.

In another example, the processing circuitry 630 is the same as processing circuitry 650, that is: The processing circuitry 650 of the computational system 610, comprising a plurality of processing circuitries 650, 660, 670, is configured to determine if a number of input data token or tokens is available at one or more input buffers of a memory space. For example, the memory space being assigned to the processing circuitry 650. The processing circuitry 650 is configured to determine if at least a portion of the memory space for a number of output data token or tokens is available at one or more output buffers assigned to the processing circuitry. The processing circuitry 650 is configured to execute an iteration of a first task of an application if it is determined by the processing circuitry 650 that the number of input data token or tokens and memory space for the number of output data token or tokens are available. All examples and techniques described below apply correspondingly in the case that processing circuitry 630 is the same as processing circuitry 650.

An application, executed by the computational system 610, may be a software program or a set of related software programs. The application may comprise one or more sub-processes, which are referred to as tasks, that can be executed independently. The distributed computation of the tasks may refer to the process of distributing the tasks of the application across multiple processing units of the computational system 610. Therefore, the application may be modelled as a model, for example a (data flow) graph.

The application may be modelled by a model comprising plurality of nodes representing tasks of the application executed by a respective processing circuitry of the computational system. Further, the model (for example a graph) may comprise connections (for example directed arcs) connecting a respective input port or ports representing input buffers assigned to a respective processing circuitry of the computational system 610 to execute a task represented by a particular node and a respective output port or ports representing output buffers assigned to the respective processing circuitry of the computational system 610 to execute the task represented by the particular node.

In another example, the application may be modeled by one or more directed graphs. For example, the one or more directed graphs may be SDF graphs.

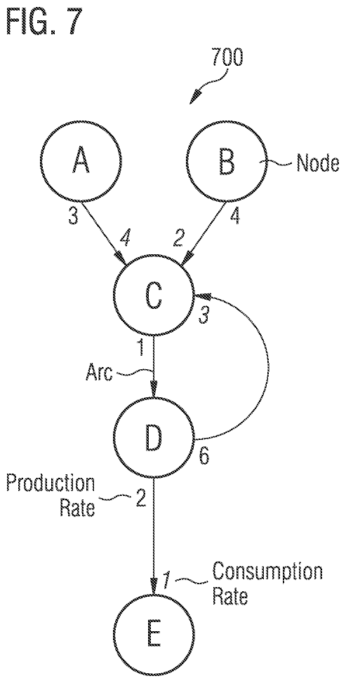

For example, the application may be modelled as a model that or as a graph (for example a a data flow graph). A Data Flow Graph (DFG) is a directed graph where nodes represent computational tasks, and edges (also referred to as arcs or connections) represent the flow of data between these tasks. The edges (arcs, or connections) may further show the relationship or information between the places where a variable is assigned and where the assigned value is subsequently used. The data-flow graph, or simply graph, may not necessarily be pictorially represented, but may also be digitally represented without the need to provide a pictorial representation in the graphic sense. Further, the nodes comprise input ports (input terminals) and output ports (output terminals). It may be a useful abstraction for describing and analyzing data-driven or event-driven computation, especially in parallel and distributed systems. Different well-known data flow models are known in the art, for example: The Synchronous Data Flow (SDF), wherein nodes represent instances of tasks of an application and directed arcs represent the data flow between those tasks. The plurality of tasks are connected and an output of the first task may be used by one or more other tasks as input. Each node may use a fixed rate of data production and consumption, ensuring bounded memory usage and enabling compile-time scheduling (see FIG. 7). A generalization of SDF may be the Cyclo-static Data Flow (CSDF), where production and consumption rates cycle over a set pattern. A further example of a data flow graph may be the Boolean Data Flow (BDF), which allows rates to be controlled by Boolean conditions, and the Dynamic Data Flow (DDF), where rates can change dynamically, making it highly expressive but also more complex to analyze. The Kahn Process Networks (KPN) model allows processes to communicate via unbounded FIFO channels, lending itself well to concurrent and distributed computation. Parameterized Data Flow introduces parametric variations in data rates, facilitating modeling of dynamically reconfigurable systems. Further, the Homogeneous Synchronous Data Flow (HSDF) is a simplified form of SDF with unitary production and consumption rates, casing analysis and scheduling tasks.

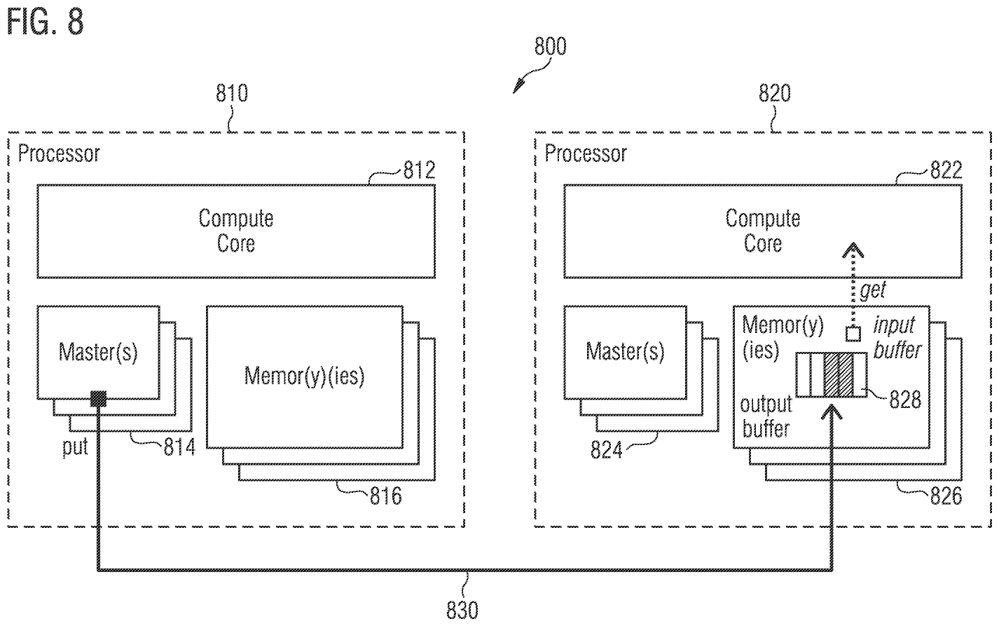

Coming back to the SDF model of an application, that is for example described in the scientific paper from Lee, Edward A., and David G. Messerschmitt, “Synchronous data flow.”, published in Proceedings of the IEEE 75.9 (1987): 1235-1245. An SDF graph is modelling an application comprising a plurality of tasks. The SDF graph comprises nodes representing tasks of an application. Data is output by the nodes representing the tasks and may be input to other nodes. The nodes in the SDF graph are connected by directed graphs (also referred to as arcs). The nodes comprise input terminals (also referred to as input ports) and output terminals (also referred to as output ports). The arcs connect output terminals and input terminals of the nodes. The input and output data of a task/node at a predetermined (some user-defined) granularity is modelled as so called tokens (see FIGS. 8-10) travelling across arcs in the graph. Further, an arc in the SDF graph may be bounded with respect to the maximum number of tokens they can hold at any given moment in time during execution. The maximum number of tokens a given arc can hold is also referred to as the capacity of that arc. Each node in an SDF graph may have one or more input ports. An input port is an input point for the node for data tokens arriving via an arc, which is originating from another node. Further, a node in an SDF graph may have one or more output ports. An output port is an output point of the node for data tokens leaving the node via an arc, which is going to another node. An output port is the point where an arc is leaving the node to another node. The SDF graph model may define a so-called firing rule for a task, that is, a condition under which a task (node) may execute one iteration of its algorithm loop. The execution of one iteration at a node may be referred to as a firing of the task (or node). The firing rule may define, that on each firing of a task, a specified number of tokens is produced at each output port. That specified number of tokens that is produced at each output port is referred to as production rate of the port of the node. The firing rule may further define that a specific minimum number of tokens may reside on each input port of the task (node), and space for a specific number of tokens may reside on all output ports of the task (node). The firing rule may further define, that on each firing of a task, a specified number of tokens is consumed at each input port. That specified number of tokens that is consumed at each input port is referred to as consumption rate of the port of the node. In the SDF model, the production rate/consumption rate may be different for each port but is known a-priori and fixed at compile/implementation time. Therefore, the tasks of the SDF graph perform the repetitive execution of the application (e.g., an algorithm) based on the availability of data tokens required in each iteration of the application. This makes task execution fully data-driven and thereby offers the opportunity to make tasks self-scheduling.

The modeling of a computational system (as 110 or 610) as described above may enable a distributed computation of tasks of an application on different computational systems (as 110 or 610). The computational system may be composed of a collection of different processing circuitries with varying levels of programmability (e.g., CPUs, DSPs, ASIPs, fixed function accelerators, I/O devices) communicating over different interconnects (e.g., hierarchies of buses, Networks-on-Chip, point-to-point connections, ring fabrics, etc.). That is the computational system (as 110 or 610) is modeled as a model comprising one or more processor types as described above.

For example, the carrying out of the tasks of the application based on a DFG model may be structured by a dataflow protocol (for example at task port level) comprising several routines and phases (for example: request, access, complete, and notify, see below). The protocol may be implemented in hardware, software, firmware, or a combination thereof. For example, the protocol may provide the task programmer with a generic mechanism to check for availability of data at input ports and space at output ports (request), to read available data and write to available space in arbitrary order (access), to finalize the consumption and production of data (complete), and to notify other tasks of such consumption and production (notify). With such a protocol, automatic task scheduling, communication, and synchronization may be obtained, while hiding implementation details from the programmer.

The above described technique may be implemented in hardware or software (or a combination thereof). The technique as described above provides a well-defined and simple task communication and synchronization protocol, enabling a task programmer to implement a task in full isolation from other tasks, fully isolated from the application DFG in which tasks are instantiated, and fully agnostic to the computational system on which the application is executed. The task programmer does not need to specify any details regarding input/output buffer locations, source and destination addresses, communication routing paths, synchronization setup, etc. All of this is hidden from the programmer and automatically taken care of by the technique as described above (for example specified in a protocol and corresponding API). Moreover, the technique as described above allows for different implementation backends be easily provided, transparent to the programmer. Examples of such different implementations may include implementations that offer various forms of acceleration for the synchronization protocol in hardware. The above described technique results in self-scheduling, self-communicating, and self-synchronizing tasks, without centralized control. Further, with the technique as described above tasks become “plug & play” in an application context, that is easy to use, reusable across different DFGs and different computational systems. This results in an elimination of low-level programming by an application developer to configure and control the scheduling, execution, communication, and synchronization of tasks on any combination of processing circuitries in a computational system, where processing circuitry types may range from fully programmable to fixed-function hardware integrated with any type of interconnect infrastructure. This decentralized form of task scheduling, execution, communication, and synchronization as described above eliminates the need for centralized control processors and interconnect, improving scalability and real-time performance bottlenecks, as well as reducing silicon cost.

The above described technique is generically applicable to different computational systems for example to (heterogeneous) multi-core system targeting digital signal processing applications (e.g., communications, imaging, video, military, AI). For example, the computational system may be composed of a 2D-mesh array of multiple (for example 40 or the like) Single Instruction, Multiple Data (SIMD)/Very Long Instruction Word (VLIW) cores, several micro-controllers, various types of fixed function hardware, such as hardware acceleration, and/or I/O peripherals. Further, the above described technique may be used with regards to dense compute solutions based on multiple (for example hundreds) of vector engines integrated into modern FPGAs.

The processing circuitry 630 is configured to write output data tokens to the one or more output buffers corresponding to the processing circuitry 650/660/670 after the executing of an iteration of the first task.

FIG. 7 illustrates a model modelling an application comprising a plurality of task. For example, the model may be a Synchronous Data Flow (SDF) graph 700 The SDF graph 700 comprises nodes A, B, C, D, E representing tasks of an application. The numbers at each arc leaving a node A, B, C, D, E represent the number of tokens that are produced by the node for that respective arc (production rate). For example, node D has a production rate of 6 for the arc connecting node D to node C and node D has a production rate of 2 for the arc connecting node D to node E. Further, the numbers at each arc arriving at a node A, B, C, D, E represent the number of tokens that are consumed by the node for that respective arc (consumption rate). For example, node C has a consumption rate of 3 for the arc connecting node D to node C and node C has a consumption rate of 2 for the arc connecting node B to node C and node C has a consumption rate of 4 for the arc connecting node A to node C.

### Tokens and Buffers

The one more input buffers assigned to the respective processing circuitry 650/660/670 to carry out the task represented by the node are storing input data tokens being read by the task. The one or more output buffers assigned to the respective processing circuitry 650/660/670 to carry out the task represented by the node are storing output data (also referred to as data) tokens being generated by the task.

Further, an input port and an output port connected by an arc represent a memory space serving as output buffer for one of the processing circuitries 650, 660, 670 and input buffer for another one of the processing circuitries 650, 660, 670.

Further, the memory space may be associated with an address space region from which the input data tokens are read by the processing circuitry 650/660/670.

The model modelling the computational system 610 for distributed computation of tasks of an application, the model comprising one or more processor types may be combined with a DFG (e.g., an SDF graph) model of the application. In this regard each arc of a DFG (e.g., an SDF graph) holding zero or more data tokens at any given time during execution of a task/application, an arc may be considered as modeling a data buffer that can hold one or more data tokens (up to capacity C) in first-in-first-out (FIFO) order (see FIGS. 8-11). In other words, data tokens travelling along arcs of a DFG (e.g., an SDF graph) in FIFO order can be modelled as FIFO buffers storing blocks of data tokens. Therefore, data input buffers for each task in the DFG may be defined as being allocated in the local address space region (identified by a memory identifier) of the processing circuitry (identified by a corresponding processing circuitry identifier) that executes the task that reads from those input buffers. In the DFG model (e.g., an SDF graph), each input buffer for a task (represented by a node) corresponds to an arc in the DFG model of the application that connects an output terminal (output port) of a node to an input terminal (input port) of another node. Further, each input buffer modelled by a given arc thus may be also viewed as the output buffer of an output terminal (output port) of a node connected to that same arc (see FIG. 7). Therefore, each arc is represented and modeled by one buffer.

FIG. 8 illustrates a buffer in a processer type of the model 800. FIG. 6 shows (a part of) the model 800 modelling a computational system for distributed computation of tasks of an application. The model 800 comprising two processor types. The model 800 comprises a first processor type 810 which comprises a first processing circuitry identifier 812 for the first processing circuitry. Further, the first processor type 810 comprises a first memory identifier 816 for the first memory space region. Further, the first processor type 810 comprises a first interface identifier 814 for the interface through which output data of the first processing circuitry is written to a second address space region identified by a second memory identifier 826. Further, the model 800 comprises a second processor type 820 which comprises a second processing circuitry identifier 822 for the second processing circuitry. The first processing circuitry may execute a task of the application. Therefore, the first processing circuitry may be represented by a first node in DFG model as described above. Further, the second processor type 820 comprises the second memory identifier 826 for the second memory space region. Further, the second processor type 820 comprises a second interface identifier 824 for the interface through which output data of the second processing circuitry is written. The address space that is identified by the second memory identifier 826 comprises one or more buffers 828. The second processing circuitry may execute a task of the application. Therefore, the second processing circuitry may be represented by a second node in DFG model as described above. The interconnect 830 between the first processor type 810 and the second processor type 820 is represented by an arc (between two nodes) in the DFG model as described above. Therefore, the arc corresponds to the buffer 828 which is an input buffer to the second processing circuitry and an output buffer to the first processing circuitry. The interface (identified by the first interface identifier 814) can access the second address space region (identified by the memory identifiers 826) of second processor type 820. The second address space region (identified by the second address space identifier 826) comprises a buffer. The second processing circuitry may access its local address space with a get indicator (see below). The first processing circuitry may output data with a put indicator (see below).

A data flow task graph of an application (for example an SDF graph), a task interface specification, and the computational system abstraction may enable abstract APIs that help a programmer to setup communication paths and storage buffers between different types of processors running one or more tasks of the application across different types of interconnects in the computational system. It further may enable tasks of the application to be developed in isolation and in a modular and composable fashion. Computational system abstraction involves abstracting device in the computational system that may participate in the compute, storage, or movement of data as a generic processor, instantiated from a specific processor type as described above.

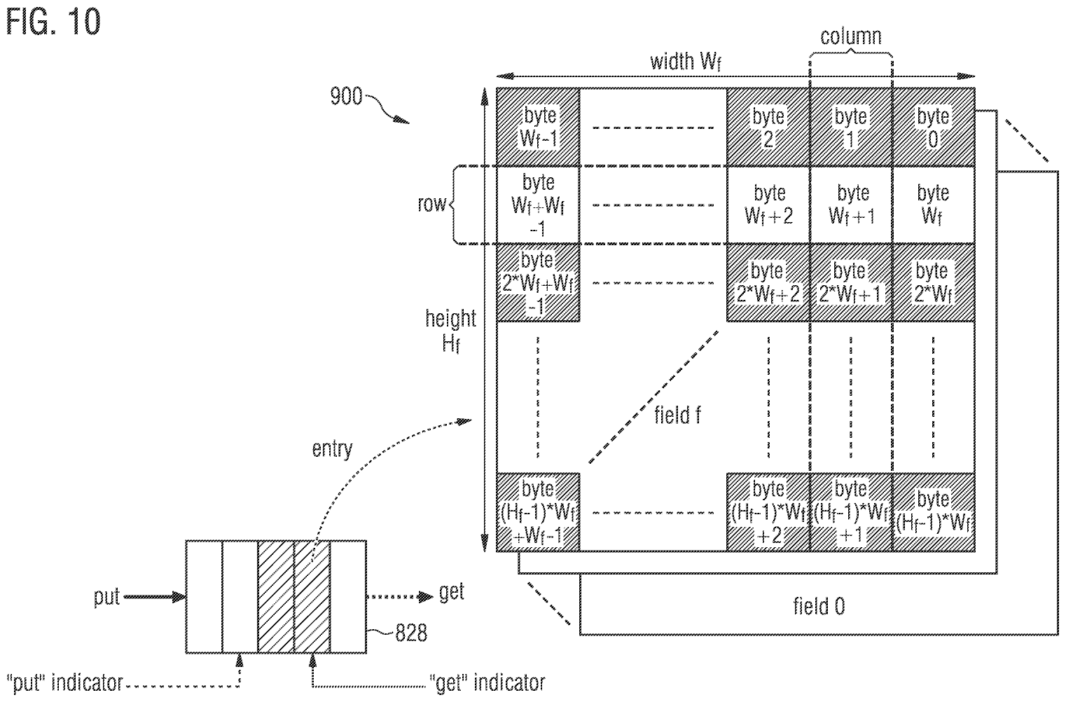

A token (also referred to as data token) represents data in a generic hierarchical data exchange format. A token may have any format or shape, with the constraint that tokens travelling across the same arc of a DFG may exhibit the same format or shape. A token consists of F fields, with each field 0≤f<F composed on a 2D block of bytes with width W_{f} expressed in bytes and height H_{f} expressed in rows of bytes (see FIGS. 9 and 10). A token format may be type-agnostic in that it defines a hierarchical view on a collection of zero or more bytes. This hierarchical view allows for the definition of multi-dimensional formats, wherein a format is defined as a list of zero or more fields, with each field dimensioned using a specific width in bytes and a height in rows.

FIG. 9 illustrates a token 900 representing a generalized data exchange format. The token 900 consists of F fields, with each field 0≤f<F composed on a 2D block of bytes with width W_{f} expressed in bytes and height H_{f} expressed in rows of bytes.

FIG. 10 illustrates the token 900 stored in the buffer 828. The token 900 is stored in the buffer 828. The buffer 828 represents an arc in the DFG model of the application and acts as input buffer as well as output buffer. A processing circuitry may access its local address space with a get indicator (see below). Another processing circuitry may output data with a put indicator (see below).

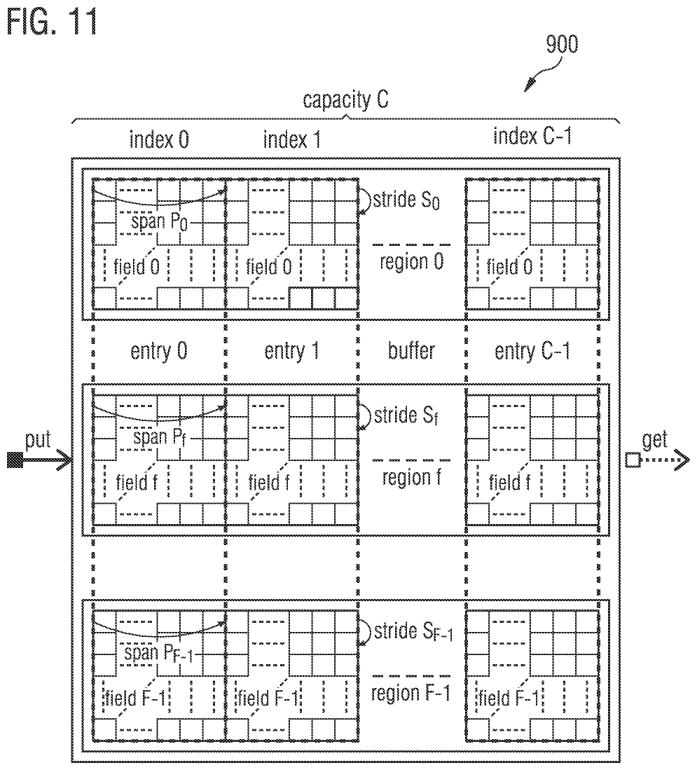

In a data buffer organized as a FIFO with each entry corresponding to a block of data organized in line with a specific data exchange format (i.e., a data token), the internals of the data buffer may be generalized in the form of a so-called buffer structure (see FIG. 11). A structure may be composed of a list of zero or more fields, where each field in the structure corresponds one to one with a specific field in the format of each entry of the buffer. The structure also defines a stride and a span for each field. The stride defines the distance in bytes between the memory-mapped addresses at which the first bytes of consecutive rows in a format field shall be stored in the corresponding buffer structure field. By default, the stride is equal to the width of the format field, but applications may use larger stride values as well. The span defines the distance in bytes between the memory-mapped addresses at which the first bytes of corresponding format fields contained in consecutive tokens shall be stored in the corresponding buffer structure field. By default, the span is equal to the height of the format field times the stride, but applications may use other span values as well. The concept of a non-default stride and span in combination with 2D dimensions (i.e., width and height) per field may for instance be applicable in a video or image processing application. In such an application, the buffer could represent a (portion of a) pixel frame stored in memory-mapped locations, that are directly derived from pixel coordinates. Each buffer entry represented by the corresponding format could then represent a 2D pixel block within this frame. Another practical use for strides and spans is in the concept of buffer overlays. In this regard, a buffer overlay is a technique where multiple data from different logical buffers (i.e., arcs) are stored into a single overlapping physical memory address space, in order to optimize memory usage. Given a structure, a buffer may be observed as being composed of a list of memory regions, with one region allocated for each field in the structure. Different regions of the same buffer can be allocated in different areas of the same memory, or even in different memories.

FIG. 11 illustrates a buffer structure. A buffer 900 with a capacity of C entries is structured such that each entry is composed of F format fields, with each field corresponding one-to-one to each of F regions. FIG. 11 also illustrates the concept of strides and spans as explained above.

Further, a buffer may be implemented in various ways (e.g., as a hardware FIFO or as a software-based modulo buffer in RAM). Moreover, each token format field may be stored in a different region in the buffer (see FIG. 11). A buffer region here implies a different memory-mapped area in physical storage, which may even mean a different physical memory of the computational system.

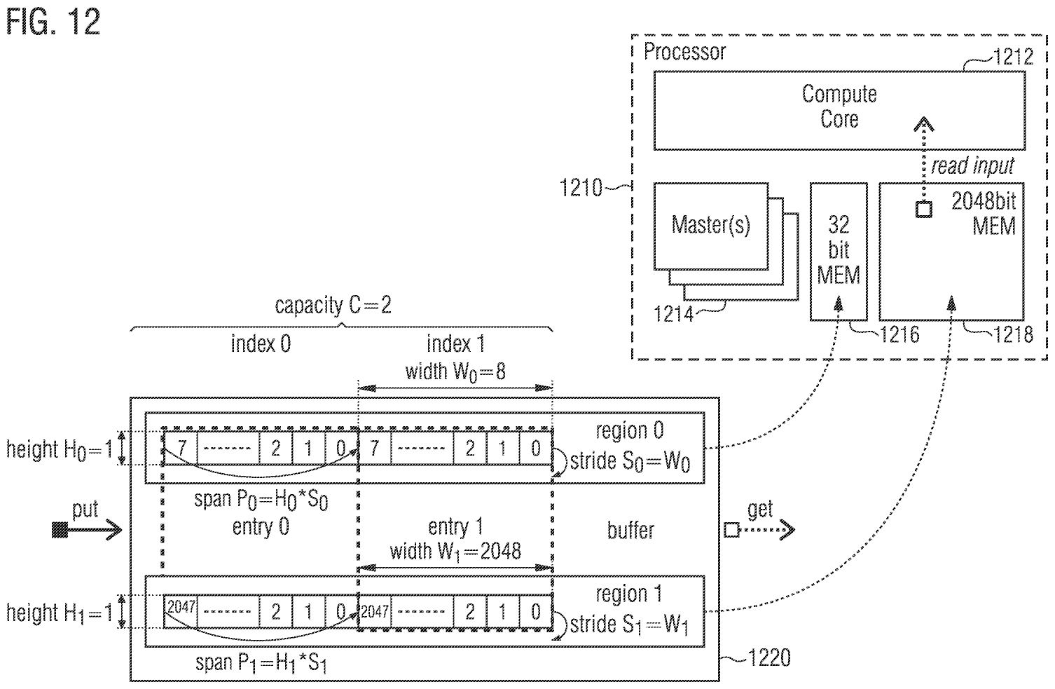

FIG. 12 illustrates a buffer 1220 with different regions allocated in different memories. FIG. 12 shows (a part of) the model modelling a computational system for distributed computation of tasks of an application. The model comprising a first processor type 1210. The first processor type 1210 comprises a first processing circuitry identifier 1212 for the first processing circuitry. Further, the first processor type 1210 comprises a first interface identifier 1214 for the interface through which output data of the first processing circuitry is written. Further, the first processor type 1210 comprises a first memory identifier 1216 for the first address space region (region 0) corresponding to an 8 byte wide field. Further, the first processor type 1210 comprises a second memory identifier 1218 for the second address space region (region 1) corresponding to a 2048 byte wide field. The first address space is allocated in a 32 bit scalar memory, and the second address space region is allocated in a 2048 bit wide vector memory. Both memories are local to the processing circuitry identified by the first processing circuitry identifier and used as input buffer 1220. Default strides and spans are used in this case, and since the height of both fields is set to 1, the strides are in fact irrelevant.

The connection between a source master interface and a destination address space region creates a link for writing data produced by a producing task output port to the memory regions used for buffering the input data for a consuming task input port, wherein that link is represented by an arc in the application model (for example graph). Each arc in the model connects to a unique terminal of a node in the model and each terminal of a given node directly corresponds to a unique port of the task instantiated by that node. To create a proper source to destination connection represented by arcs in a model, a specification defining how the ports of a given task are related to master interface identifiers and memory identifiers of the processor type on which that task of the application is mapped may be defined. An example of this mapping is provided below using standard C preprocessor macro syntax:

```
SDF STRUCTURE(
  pixel_block, /* user-defined identifier given to this structure */
  SDF_FORMAT( /* token format: */
    SDF_FIELD_DIMENSION(4), /* field 0 having a width of 4 bytes */
    SDF_FIELD_DIMENSION(16,8) /* field 1 having a width of 16 bytes
        * and a height of 8 rows
        */
  ),
      /* field 0 using no stride and default alignment */
  SDF_FIELD_STRIDE(1, 2048), /* field 1 having a stride of 2048 bytes */
  SDF_FIELD_ALIGNMENT(1, 128) /* field 1 having an alignment of 128 bytes */
);
```

A token format and buffer structure as described above is used. The above example specification shows a buffer structure and corresponding token format identified as “pixel_block”, that consists of a header field 0 composed of 4 bytes and a payload field 1 composed of a 2D-block of bytes that is 16 bytes wide and 8 rows high. It further specifies some stride and alignment constraints for each buffer region required for the format. Thus, each field f specified above directly corresponds to a buffer region r=f. Similar to the example given above two simple token formats and buffer structures, i.e., a packet and a value structure may be defined as given below:

```
  SDF_STRUCTURE(packet, SDF_FORMAT(SDF_FIELD_DIMENSION(8),
SDF_FIELD_DIMENSION(2048)));
  SDF_STRUCTURE(value,
SDF_FORMAT(SDF_FIELD_DIMENSION(2048)));
```

A generated processor type of a model modelling a computational system as described above (see the example algorithm give above) can be used to specify a task of an application on a processor type using the SDF model as described above. A task of an application is defined using an SDF_TASK interface specification macro given in algorithm below. The example algorithm below shows a task of an application modeled as a node with two input ports and one output port. The task may be carried out by any instance of the processing circuitry of the computational system 110/610 (processor core) of the type “compute_engine”. An example algorithm is given below:

```
SDF_TASK(
  calc, // a task named ‘calc’
  compute_engine, // targeting any instance of a ‘compute_engine’ processor type
  SDF_IPORT( // an input port
    in0, // named ‘in0’
    2, // consumption rate of 2 tokens per task firing
    packet, // using a ‘packet’ token format / buffer structure
    SDF_MMIO( 0, 1 ) /* using memory 0 ‘SYSRT_ID_compute_engine_coreio_sdlm’
        * to buffer data corresponding to token format field 0
        * using memory 1 ‘SYSRT_ID_compute_engine_coreio_vdlm’
        * to buffer data corresponding to token format field 1
        */
    SDF_ACCELERATED // optional attribute: using SDF protocol acceleration
  ),
  SDF_IPORT( in1, 2, value, SDF_MMIO( 1 ) ), // another input port
  SDF_OPORT( // an output port
    out, // named ‘out’
    2, // production rate of 2 tokens per task firing
    value, // using a ‘value’ token format / buffer structure
    SDF_MMIO( 1 ) /* using master 1 ‘SYSRT_ID_compute_engine_coreio svdlm’
      * to produce data corresponding to token format field 0
      */
  )
);
```

In the above example, through this specification a relation is created between each task port of the node (the token format and buffer structure the port is assuming for tokens produced or consumed on the port), and the of master interfaces identifiers and memories identifiers of the processor type used to communicate those tokens. For example, input port “in0” is specified to use a “packet” structure, which uses a token format containing two fields. For each of these two fields, an index is specified via an SDF_MMIO( . . . ) macro. For any input port, this macro links each specified index provided as argument (listed in order of the format field and thus the buffer region it corresponds to) to a corresponding memory identifier specified for the “compute_engine” processing circuitry. In this case, field/region 0 is specified to use the first memory (index for 0) specified for “compute engine”, which is SYSRT_ID_compute_engine_coreio_sdlm, and field/region 1 is specified to use the second memory (index 1) specified for specified for ‘compute engine’, which is SYSRT_ID_compute_engine_coreio_vdlm. Similarly output port “out” is specified to use a “value” structure, which uses a token format containing a single field. For any output port, the SDF_MMIO( . . . ) macro links each specified index provided as argument (listed in order of the format field and thus the buffer region it corresponds to) to a corresponding master interface identifier specified for the “compute_engine” processing circuitry. In this case, field/region 0 is specified to use the second master interface (index 1) specified for “compute engine”, which is SYSRT_ID_compute_engine_coreio_vmdlm.

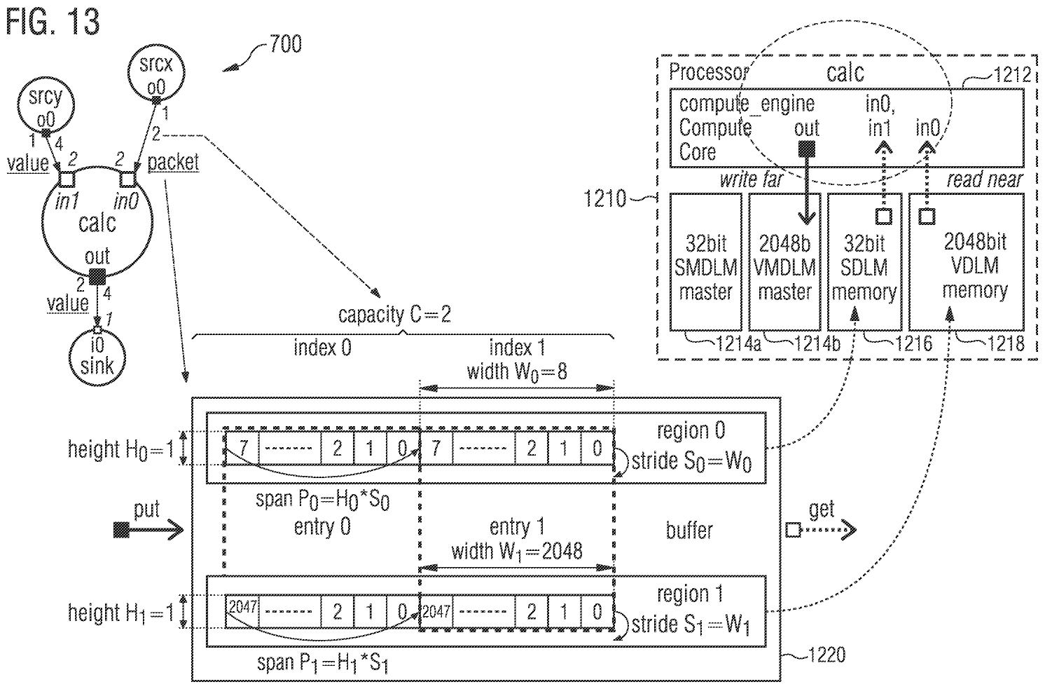

FIG. 13 illustrates the relation between an arc in an SDF model of an application a token format/buffer structure and a processor type processing circuitry instance. The application is instantiated on the model 700 (see FIG. 7) modelling an application comprising a plurality of task. Each task is assigned to a node in the model. Each node is instantiated by a specific processing circuitry which is modeled by a processor type, as for example the processor type 1210 (see FIG. 12). The processor type 1210 comprises a first processing circuitry identifier 1212 for the first processing circuitry. Further, the first processor type 1210 comprises an interface identifiers 1214a and 1214b for the interfaces through which output data of the first processing circuitry is written. Further, the first processor type 1210 comprises a first memory identifier 1216 for the first address space region (region 0) corresponding to an 8 byte wide field. Further, the first processor type 1210 comprises a second memory identifier 1218 for the second address space region (region 1) corresponding to a 2048 byte wide field. The first address space is allocated in a 32 bit scalar memory, and the second address space region is allocated in a 2048 bit wide vector memory. Both memories are local to the processing circuitry identified by the first processing circuitry identifier and used as input buffer 1220. Default strides and spans are used in this case, and since the height of both fields is set to 1, the strides are in fact irrelevant. A system-level API as described above can now automatically derive and configure the necessary communication links in the system to which the application is mapped. Moreover, given the token format specified for each task port and thereby for each model node terminal, and the maximum capacity expressed in number of tokens for each arc in the model connecting those terminals, it can allocate the necessary buffers throughout the system within the proper memories. This may include both allocating random access memory, as well as custom hardware buffer space, such as hardware FIFOs.

Thereby the complexity of the underlying computational system 110/610 (a heterogeneous multi-processor system) is hidden from the application programmer when setting up communication and buffering between communicating tasks. Therefore, the above describe technique enables a to carry out to carry out and execute (distributed) tasks of an application on computational system (for example a multi-core system like a SoC) faster, with less system failures more efficiently and with less power consumption.

### Put Indicator and Get Indicator

The tokens and spaces on arcs may be tracked, i.e., determining the state of each arc in the graph of the DFG at any given moment in time, and identifying the position of tokens produced or consumed on each arc by the respective nodes.

The buffers may be FIFO modulo buffers. That is to model the tracking of tokens and spaces on an arc, an arc may be modelled as FIFO modulo buffer that can hold a number of tokens up to a specified capacity. A FIFO modulo buffer refers to the method of addressing buffer locations modulo the buffer size (capacity). This allows the addressing to wrap around back to the start once the end of the buffer is reached. This creates a circular or continuous data flow within the buffer, enabling an efficient mechanism for handling streaming tokens in a cyclic manner.

In one example the capacity of each arc in the DFG model is determined at compile time based on graph analysis as for example described in the scientific paper from Lee, Edward A., and David G. Messerschmitt, “Synchronous data flow.”, published in Proceedings of the IEEE 75.9 (1987): 1235-1245.

The processing circuitry 630 is configured to track available space for output data (also referred to as data) tokens in one or more output buffers of the processing circuitry 650 corresponding to one or more input buffers of further processing circuitries 650/660/670 in the computational system 610 based on a put indicator for each of the buffers.

Further, the processing circuitry 630 is configured to track the number of available input data tokens in the one or more input buffers assigned to the processing circuitry 650 in the computational system 610 based on a get indicator for each of the one or more input buffers.

Further, the processing circuitry 630 may be configured to track the number of available input data tokens in a buffer with a get indicator and track the available space for output data tokens in the buffer with a put indicator, wherein the buffer is corresponding to an arc, representing a corresponding input buffer and output buffer.

To track the arc FIFO buffer state status (i.e., the number of tokens or spaces available in the buffer), the production and consumption of tokens on an arc is managed using so-called indicators. The indicator for an output terminal that produces tokens on the arc is referred as put indicator. The indicator for an input terminal that consumes tokens from the arc is referred as get indicator.

On each firing of a node of the DFG a number of tokens is produced on a given terminal of that node, which is referred to as the production rate of that terminal. Correspondingly, on each firing of a node of the DFG a number of tokens is consumed by a given terminal of that node, which is referred to as the consumption rate of that terminal. Therefore, an increment value for an indicator is equal to that (consumption/production) rate. That is on each firing of a node the indicator for each terminal of that node is modulo-incremented by its rate, taking into account the capacity of the corresponding arc.

An example algorithm, of the incrementation of the indicator is given below:

$$indicator = ( indicator + rate ) \% ( 2 * capacity ) ;$$

Further, an example algorithm of get and put indicators for an arc of a DFG model determining an arc state can is given below:

```
if ((put_indicator >= capacity) && (get_indicator < capacity))
  spaces = put_indicator − get_indicator − capacity;
else
  spaces = put_indicator − get_indicator + capacity;
tokens = capacity − spaces;
```

The variable “spaces” in this algorithm represents the number of empty spaces available on the arc, and the variable “tokens” represents the number of available tokens on the arc.

The relative position of tokens on an arc, that is within the arc FIFO buffer, may be referred to as a token index. The relative position of a next token to be produced on an arc may be referred to as put index, and the relative position of a next token to be consumed from an arc may be referred to as get index. Given that an arc may have bounded capacity C, the values of these indexes may be constrained to lie within a range [0 . . . C−1].

Further, an example algorithm of an index, for a given indicator, pointing to the actual token may be obtained as follows:

$$index = indicator \% capacity ;$$

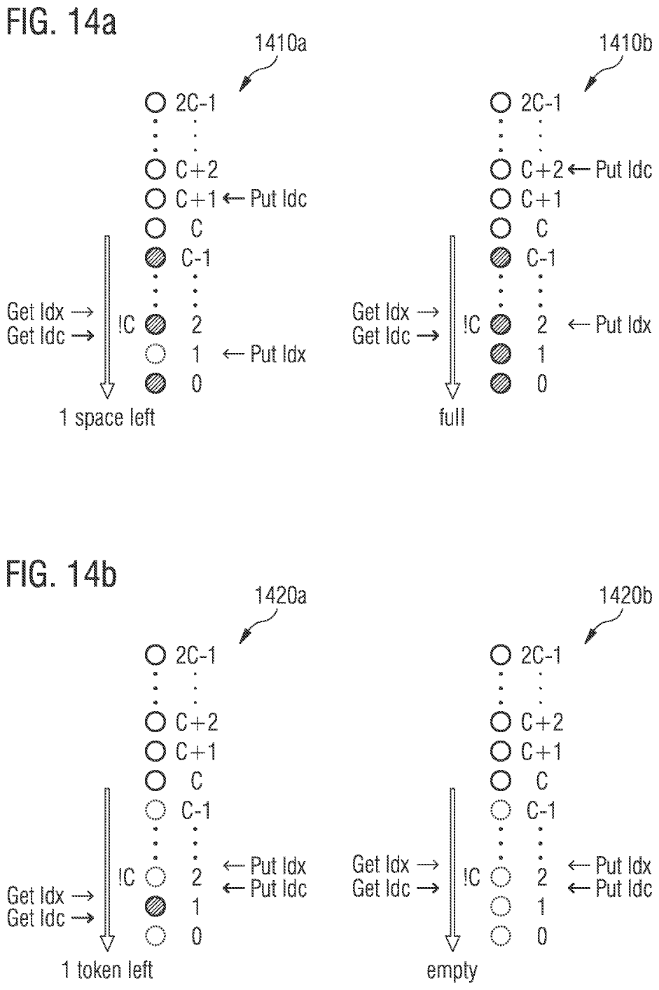

FIG. 14a illustrates tracking tokens on an arc in a full state using indicators and deriving token position using indices. The arc (buffer) 1410 has a capacity C. The arc in a first state 1410a has one space, at location “1”, left. The put index places a produced token at location “1”. Then in state 1410b the arc is full and has no free spaces left.

FIG. 14b illustrates tracking tokens on an arc in an empty state using indicators and deriving token position using indices. The arc (buffer) 1420 has a capacity C. The arc in a first state 1420a has one space occupied, at location “1”. The get index obtains a consuming token at location “1”. Then in state 1420b the arc is empty and has no occupied spaces.

The processing circuitry 630 is configured to update the put indicators for each of the one or more output buffers after execution of the first task based on a production rate of a corresponding output port of the first task.

The processing circuitry 630 is configured to update the get indicators for each of the one or more input buffers after execution of the first task based on a consumption rate of a corresponding input port of the first task.

The state of each arc (that is an input buffer and the corresponding output buffer) in the DFG model may be tracked using the get and put indicators as described above. The put indicator may be updated after execution of the first task based on the production of tokens on the arc and based on the production rate. The get indicator may be updated after execution of the first task based on the consumption of tokens from the arc and based on the consumption rate. The production of tokens on a given arc and the consumption of tokens from that arc may be by distinct task instances connected via that arc from the first task. The nodes may be run on the same or on different processing circuitries, or in different threads on the same processing circuitry or the like. Therefore, for updating the get indicators and put indicators in a DFG modelling an application, indicator ownership and indicator sharing as described below may be used.

The processing circuitry 630 is configured to share the updated put indicators for each of the one or more output buffers with the corresponding one or more input buffers connected by respective arcs.

The processing circuitry 630 is configured to share updated get indicators for each of the one or more input buffers with the corresponding one or more output buffers connected by respective arcs.

For a given arc in a DFG model, indicator ownership for that arc may define that the put indicator of the arc is owned by the producing terminal connected to the tail of an arc. Further, the indicator ownership for that arc may define that the get indicator is owned by the consuming terminal connected to the head of an arc. Ownership in this regard may imply that maintaining and modulo-incrementing (modulo with regards to capacity C) the indicator is performed by and is the responsibility of the owner. That is the producer owns all information required to determine the put index for the next token to be produced, provided there is space, and the consumer owns all information required to determine the get index for the next token to be consumed, provided tokens are available. In this regard the indicator owned by a given terminal (i.e., port of the first task), is referred to as the local indicator of that terminal.

The local indicator may be sufficient to determine the relevant index for production or consumption of tokens by a given terminal on a given arc after execution of the first task. However, the terminal may need additional information to determine whether sufficient space or tokens are available to proceed with production and consumption on that arc. This additional information is provided by the local indicator value owned by the other terminal connected to the arc. To obtain this additional information, the producer and consumer terminals connected to a given arc need to share their local indicator values with each other.

The consumer may share a copy of its own updated get indicator with the producer, such that the processing circuitry may determine the amount of space available on the arc using its own put indicator and the shared get indicator copy. Similarly, the producer may share a updated copy of its own put indicator with the consumer, such that the consumer may determine the number of available tokens on the arc using its own get indicator and the shared put indicator copy.

The local indicator values may only be updated with each production or consumption of rate tokens by a given terminal. Therefore, the moment of sharing a copy of an updated local indicator may immediately follow that of completing production or consumption of tokens after execution of the first task. The terminal connected to the other end of an arc connected to a given terminal, may be referred to as remote terminal of that given terminal and therefor the indicator copy value provided by a given terminal to its remote terminal, may be referred to as remote indicator. Therefore, the sharing of a local indicator after execution of the first task, may amount to the first task (the node executing the first task) writing that indicator to a predefined address and the remote task it is communicating with, may expect its remote indicator.

By updating the get and put indicator as described above, it can be achieved that a producing task of tokens may determine that there is sufficient space available to put tokens on the tail of the arc, given that consumption and thus the get indicator control is handled by another task connected to the head of the arc. Further, it can be achieved that a consuming task of tokens may determine that there are sufficient tokens available to get tokens from the head of the arc, given that production and thus the put indicator control is handled by another task connected to the tail of the arc.

Given the above described technique of owning, sharing, and checking indicators to determine whether nodes in a DFG may fire, a (self-scheduling) task executed by a processing circuitry 630 of the computational system 610 may carry out the following steps: Updating owned indicators taking the capacity C of connected arcs into account. Initiating the sharing of those owned indicators. Checking owned local indicators and shared remote indicators to determine whether the task can invoke its activity.

The technique to execute tasks of an application in a self-scheduling and synchronized way as described above may be formalized into a synchronization and communication protocol. Further, that protocol may be utilized in an API (for SW/FW-based tasks) that can be used by the task programmer. In line with the firing rules as described above it may further be beneficial for self-scheduling and execution of tasks of an application to properly manage and analyze a buffer state. Further, it may be beneficial to simplifying hardware implementation and/or software programming of this functionality by formalization and abstraction of the buffer management and analysis by a simple protocol and corresponding API as described above protocol and API.

### Further Examples

For example, a formalized protocol, referred to as task protocol, and corresponding API, referred to as task API, may comprise four main phases as described above. These four phases may be in logical order: 1. Request tokens or spaces. 2. Access, i.e., consume or produce, token content. 3. Complete production or consumption of tokens. 4. Notify completion of production or consumption of tokens. The task protocol and the 4 phases may be used on task of an application modelled with a DFG model for example as an SDF graph. In the following an example implementation of the 4 phases are described:

Request: During the request phase of the task protocol all ports of a task may be individually monitored to confirm that the state of the arc connected to each ports meets the firing rule for the task. For every port of a task, the following algorithm may be carried out during the request phase:

```
available = 0;
while {available < port−>rate} {
  if (port−>mode == IN )
    available = tokens(
      port−> local_indicator, // for input ports, local indicator is get indicator
      port−>capacity,
      port−>remote_indicator // for input ports, remote indicator is put indicator
    );
  else if (port−>mode == OUT)
    available = spaces(
      port−>remote_indicator,// for output ports, remote indicator is get indicator
      port−>capacity,
      port−>local_indicator // for output ports, local indicator is put indicator
    );
}
```

In the above algorithm, “tokens” and “spaces” variables are calculated based on the supplied get and put indicators and arc capacity using the algorithm described above. Upon exit out of the while loop in the algorithm, the firing condition for the port is met. If and only if the firing conditions for all ports of the task are met, the firing rule of the task is met and hence the protocol moves to into the next phase.

Access: During the access phase of the task protocol the content of all requested tokens and spaces across all ports of a task is read and written, respectively. For each input port of a task that may be instantiated by the node, for example the following algorithm is carried out:

```
// calculate index using indicator modulo capacity
index = port−>local_indicator % port−>capacity;
// access a number of tokens equal to rate
for (i = 0; i < port−>rate; i++) {
  // access content across all regions of the buffer associated with the port
  for (j = 0; j < port−>num_regions; j++) {
    // read input data from content region j of token at index in buffer
    input_data[j] = *(&port−>regions[j] + index);
    //
    // ... compute goes here
    //
    // increment index modulo capacity
    index = (index + 1) % capacity;
  }
}
```

Similarly, to the above for every output port of a task instantiated by the node, for example the following algorithm may be carried out:

```
// calculate index using indicator modulo capacity
index = port−>local_indicator % port−>capacity;
// access a number of tokens equal to rate
for (i = 0; i < port−>rate; i++) {
  // access content across all regions of the buffer associated with the port
  for (j = 0; j < port−>num_regions; j++) {
    //
    // ... compute goes here
    //
    // write output data to content region j of token at index in buffer
      *(&port−>regions[j] + index) = output_data[j];
    // increment index modulo capacity
    index = (index + 1) % capacity;
  }
}
```

That is, based on the local indicator, the local index pointing to the next available token or space on the arc is obtained. Using that local index as a starting point, the algorithm runs an outer loop iterating over a specific number of tokens to be produced or consumed, where that number of tokens is equal to the rate of the port. Within the loop, the token index is used to obtain an offset added to the base of each buffer region holding token content for the port. The resulting base plus offset points to the actual token content (or content space) that can now be accessed for processing. In processing, knowledge of the token format and buffer structure is used to access all token content. After processing the content of a token from the input buffer and producing the results in the output buffer, the index is incremented modulo the capacity of the arc connected to the port.

Completion: The completion phase of the task protocol may involve the updating of the local indicator owned by each port of a task at the end of the firing of that task. Updating this local indicator advances the indicator by a specific number of positions equal to rate, which implies that on the next firing of the task, each port will see the next available token or the next available space to be used for that firing. An example for the algorithm for completion phase is given below (also described above):

$$port -> local\_indicator = ( port -> local\_indicator + port -> rate ) \% ( 2 * port -> capacity ) ;$$

Notification: The notification phase of the task protocol may involve the sharing of the local indicator value of a port with its remote port. Given the destination for that remote indicator by a pointer named indicator_share. An example of an algorithm for notification may be as follows:

$$* port -> indicator\_share = port -> local\_indicator ;$$

The code line port→indicator_share=& remote(port)→remote_indicator; and remote(port) refers to the port connected to the other end of the arc connected to port. Notification occurs after completion and finalizes the firing of a task, by effectively removing tokens from input arcs, or adding tokens to output arcs.

The task protocol as described above may be utilized in a corresponding task API as for example described below. The API may allow a task programmer to perform the following steps which are based on the protocol algorithms as described above:

Perform a non-blocking check for sufficient tokens or spaces on an arc connected to a port, while retrieving an index of a next token (to become) available on the arc:
bool sdf_check(port, unsigned int*index);

Alternatively, perform a blocking request for sufficient tokens or spaces on an arc connected to a port, while retrieving an index of a next token (to become) available on the arc:
void sdf_request(port, unsigned int*index);

Access an arc connected to a port to read a data word of specified type from token at a specified index, within a specified token format field, column and row:
void sdf_get(type, &data, port, index, field, column, row);

Access arc connected to a port to write a data word of a specified type to token at a specified index, within a specified token format field, column and row:
void sdf_put(type, data, port, index, field, column, row);

Update (i.e., modulo-increment) token index to point to the next token or token space available for consumption or production at the specified port:
unsigned int sdf_next(port, index);

Complete of production or consumption of tokens at port:
void sdf_complete(port);

Notify completion of production or consumption of tokens from an arc connected to a port, to remote port connected to another end of the arc:
void sdf_notify(port);

An example task program (fragment) which is using the above task API based on the task protocol is given below:

```
  void calc_{——}access(int in0_index, int in1_index, int out_index) {
  // consume and produce rate tokens on each port
  // Note, here the rate is assumed to be the same for all ports of the task
  for (int i = 0; i < sdf_rate(out); i++) {
    // read input token content from proper buffer region locations
    int a;
    sdf_get(get_v_int_t, &a, in0, in0_index, 0, 0);
    int b;
    sdf_get(get_v_int_t, &b, in1, in1_index, 0, 0);
    int c;
    sdf_get(get_s_uint_t, &c, in0, in0_index, 1, 0, 0);
    // compute result
    // Note, this is only a trivial example. In real-life cases compute would
    // typically involve significantly more calculations
    // as required to implement a complete algorithm
    int sum = (c % 2 == 0)? A + b : a − b;
    // write result as output token content into proper buffer region location
    sdf_put(put_s_int_t, sum, out, out_index, 0, 0, 0);
    // modulo-increment indices
    in0_index = sdf_next(in0, in0_index);
    in1_index = sdf_next(in1, in1_index);
    out_index = sdf_next(out, out_index);
  }
}
int calc_{——}activity( ) {
  unsigned int in0_index, in1_index, out_index;
  // request tokens at input ports and spaces at output ports
  sdf_request(in0, &in0_index);
  sdf_request(in1, &in1_index);
  sdf_request(out, &out_index);
  // access and compute on token content pointed to by indices
  calc_{——}access(in0_index, in1_index, out_index);
  // complete consumption at input ports and production at output ports
  sdf_complete(in0);
  sdf_complete(in1);
  sdf_complete(out);
  // notify consumption and production completion
  sdf_notify(in0);
  sdf_notify(in1);
  sdf_notify(out);
  // count the number of times the activity is invoked
  static int fire_count = 0;
  fire_count++;
  // set return status to non-zero value to force exit after firing 10 times
  return (int) (fire_count == 10);
  }
  void calc( ) { // entry function of the task
  // perform task initialization
  int calc_{——}status = 0;
  // repetitively invoke task activity until non-zero status is returned
  do {
    calc_{——}status = calc_{——}activity( );
  }
  while(calc_{——}status == 0);
  }
```

Additionally, or instead to the above task protocol and task API further functions may be provided. For example, these functions may bring additional abstraction for the task programmer by performing the task protocol as described above on a on a per task basis instead of on a per-port basis. Thereby more powerful acceleration options in hardware may be enabled. This may comprise:

Performing a non-blocking check of a firing rule for the task, while retrieving a vector of indices pointing to the next tokens (to become) available on the arcs connected to the node that instantiates the task:
bool sdf_check_all(vint16_t*indices);

Performing a blocking check of firing rule for the task, while retrieving a vector of indices pointing to the next tokens (to become) available on the arcs connected to the node that instantiates the task:
void sdf_request_all(vint16_t*indices);

Completing and notifying completion of a production or consumption of tokens on all ports of the task:
void sdf_complete_and_notify_all( )

In yet another example, additionally or instead to the above APO, further extensions to the API may be made to abstract the determination of the next task ready for execution. This extension may be useful when multiple tasks are assigned to be executed on the same processing circuitry and provide an opportunity for implementing the task scheduling in hardware for such processing circuitries. This may comprise:

Performing a non-blocking selection of the next task that meets the DFG firing rule and is thus ready for execution, while retrieving a vector of indices pointing to the next tokens (to become) available on the arcs connected to the node that instantiates the selected task, as well as a pointer to the task activity function, i.e. the function that shall be called each time the task fires:
bool sdf_find_task(void (*activity)(vint16t*), vint16_t*indices);

Performing a blocking selection of the next task that meets the DFG firing rule and is thus ready for execution, while retrieving a vector of indices pointing to the next tokens (to become) available on the arcs connected to the node that instantiates the selected task, as well as a pointer to the task activity function, i.e. the function that shall be called each time the task fires:
void sdf_pick_task(void (*activity)(vint16t*), vint16_t*indices);

Selecting of tasks by above API functions could involve different selection schemes, e.g., round-robin or priority-based selection, potentially including a means to dynamically lower or raise priorities. Such features may also be supported by acceleration hardware.

Further, a computational system (for example the computational system 610) comprises the apparatus with circuitry configured to perform the technique as described above. The computational system may further comprise the plurality of processing circuitries (for example 630, 650, 660, 670). A first processing circuitry (for example processing circuitry 630) of the plurality of processing circuitries of the computational system is configured to determine if the number of input data token or tokens is available at one or more input buffers of the memory space assigned to a second processing circuitry (for example processing circuitry. The first processing circuitry (for example 630) may further be configured to determine if at least a portion of the memory space for the number of output data token or tokens is available at one or more output buffers assigned to the second processing circuitry. Furthermore, if it is determined that the number of input data token or tokens and that memory space for the number of output data token or tokens are available, then the first processing circuitry (for example 630) is configured to control the second processing circuitry of the computational system to execute the iteration of the first task of the application.

As also described above the first processing circuitry 630 may be the same as the processing circuitry 650 (or the same as the processing circuitry 660 or the same as the processing circuitry 672). That is the first and second processing circuitry as described above may be the same. All examples and techniques described above may apply correspondingly in the case that (first) processing circuitry 630 is the same as the (second) processing circuitry 650 as described next.

A computational system may comprise a plurality of processing circuitries. A first processing circuitry (for example processing circuitry 650 which is the same as processing circuitry 630 as described above) of the plurality of processing circuitries of the computational system is configured to determine if a number of input data token or tokens is available at one or more input buffers of the memory space assigned to the first processing circuitry. The first processing circuitry (for example processing circuitry 650) may further be configured to determine if at least a portion of the memory space for a number of output data token or tokens is available at one or more output buffers assigned to the first processing circuitry. Furthermore, if it is determined that the number of input data token or tokens and that memory space for the number of output data token or tokens are available, then the first processing circuitry 650 is configured to execute the iteration of a first task of an application. The application may be modelled by a model. The model may comprise: One or more nodes representing tasks of the application executed by a respective processing circuitry of the computational system. Further, the model may comprise connections (directed arcs) connecting a respective input port or ports representing input buffers assigned to a respective processing circuitry to execute a task represented by a particular node and a respective output port or ports representing output buffers assigned to the respective processing circuitry to execute the task represented by the particular node.

Further, computational system as described above may further comprising a second processing circuitry (for example processing circuitry 660) in the plurality of processing circuitries. The second processing circuitry of the plurality of processing circuitries of the computational system is configured to determine if a number of input data token or tokens is available at one or more input buffers of the memory space assigned to the second processing circuitry. Further, the second processing circuitry of the plurality of processing circuitries of the computational system is configured to determine if at least a portion of the memory space for a number of output data token or tokens is available at one or more output buffers assigned to the second processing circuitry. Further, the second processing circuitry of the plurality of processing circuitries of the computational system is configured to execute an iteration of a second task of the application, if it is determined that the number of input data token or tokens and that memory space for the number of output data token or tokens are available.

The application may comprise a plurality of tasks, for example the first task and the second task that may be carried out each by different processing circuitries.

That technique as described above may be carried out decentralized. That is, for example each of the processing circuitries of the computational system may be configured to carry out the techniques as described above (i.e., configured to control to determine the number of input tokens/output space and configured to execute the iteration of the first task) independently from each other processing circuitry in the computational system on their own. For example, each processing circuitry may carry out one task of the plurality of tasks of the application. Or the technique as described above may be carried out (fully or partly) centralized. That is one or more other processing circuitries of the computation system are controlled by one central processing circuitry.

The computational system 610 may be executing DSP applications. The DSP applications may be software defined radio, wireless communication, audio processing, image processing, video codecs, video processing, AI, military applications or the like. The computational system 610 may be a SoC.

Further, the technique as described above may relate to a programming model, protocol and corresponding API(s) that may be described in a programmer's manual or cookbook, related training material, and code examples. An (API) implementation may be accelerated through special hardware support, such as custom instructions that are typically described in an instruction set reference manual. Full hardware implementations of the synchronization protocol that underlies an API may require configurability of such hardware at application initialization time.

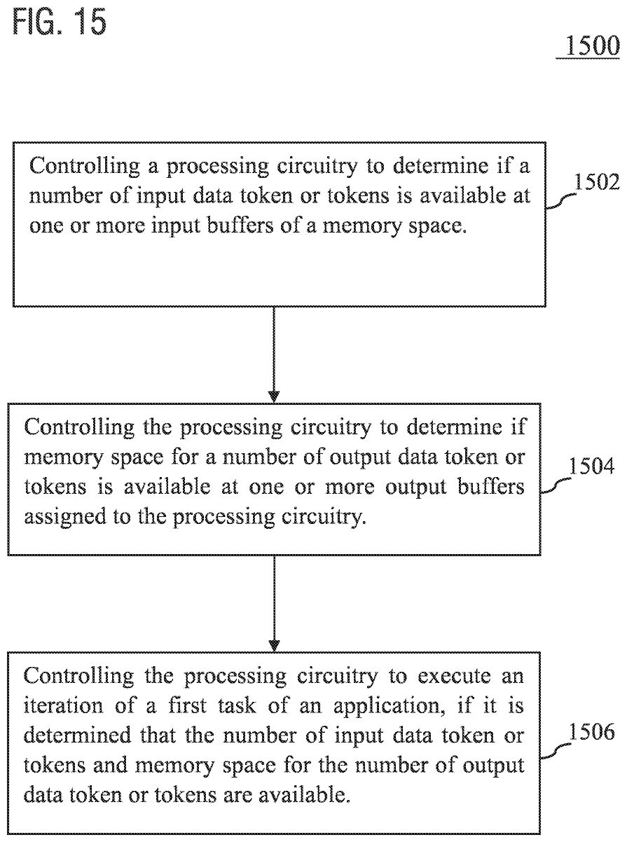

Summarizing the above, FIG. 15 further illustrates a flowchart of an example of a (e.g. computer-implemented) method 1500. The method 1500 comprises controlling 1502 a processing circuitry of a computational system including a plurality of processing circuitries to determine if a number of input data token or tokens is available at one or more input buffers of a memory space (for example the memory space being assigned to the processing circuitry). The method 1500 further comprises 1504 controlling the processing circuitry to determine if at least a portion of the memory space for a number of output data token or tokens is available at one or more output buffers assigned to the processing circuitry. The method 1500 further comprises, if it is determined that the number of input data token or tokens and memory space for the number of output data token or tokens are available, controlling 1506 the processing circuitry to execute an iteration of a first task of an application, the application being modelled by a model. The model is comprising: one or more nodes representing tasks of the application executed by a respective processing circuitry of the computational system; and connections (for example directed arcs) connecting a respective input port or ports representing input buffers assigned to a respective processing circuitry to execute a task represented by a particular node and a respective output port or ports representing output buffers assigned to the respective processing circuitry to execute the task represented by the particular node.

The method as described above may be carried out by the same processing circuitry that is controlled by the method (i.e., controlled to determine the number of input tokens/output space and execute the iteration of the first task). Or the method may be carried out by another processing circuitry than the one that is controlled. That is the method may be carried out decentralized by each processing circuitry in a computational system on its own and independently from each other processing circuitry in the computational system. For example, each processing circuitry may carry out one task of the plurality of tasks of the application. Or the method may be carried out (fully or partly) centralized by a central processing circuitry, controlling one or more processing circuitries in the computational system to carry the method.

More details and aspects of the method 1500 are explained in connection with the proposed technique or one or more example described above. The method 1500 may comprise one or more additional optional features corresponding to one or more aspects of the proposed technique, or one or more example described above.

In the following, some examples of the proposed concept are presented:

An example (e.g., example 1) relates to an apparatus comprising interface circuitry, machine-readable instructions, and processing circuitry to execute the machine-readable instructions to generate a model modelling a computational system for distributed computation of tasks of an application, the model comprising one or more processor types, wherein the computational system comprises a plurality of processing circuitries, physical memory and a respective memory address space, and one or more interconnects for communication between the plurality of processing circuitries and the physical memory, wherein a processor type includes a processing circuitry identifier, a memory identifier, and an interface identifier, and to generate a first processor type comprises providing a first processing circuitry identifier for a first processing circuitry, providing a first memory identifier for a first address space region of the address space, the first address space region being an address space from which input data is read by the first processing circuitry during task execution, providing a first interface identifier for an interface of the first processing circuitry through which data of the first processing circuitry is written to a second address space region.

Another example (e.g., example 2) relates to a previous example (e.g., example 1) or to any other example, further comprising that the processing circuitry is to execute the machine-readable instructions to generate for the first interface identifier one or more interconnect identifiers for the interconnects for communication through which data is written from the interface of the first processing circuitry to address space regions for one or more memory identifiers in one or more processor types for one or more processing circuitries of the computational system.

Another example (e.g., example 3) relates to a previous example (e.g., one of the examples 1 to 2) or to any other example, further comprising that the processing circuitry is to execute the machine-readable instructions to generate a second processor type including a second processing circuitry identifier for a second processing circuitry of the plurality of processing circuitries, generate a second memory identifier for the second address space region of the address space, the second address space region being an address space from which input data is read by the second processing circuitry during task execution, generate a second interface identifier for an interface of the second processing circuitry through which data of the second processing circuitry is written to a third address space region of the address space, wherein the second address space region in the address space to which data of the first processing circuitry is written is corresponding to the second memory identifier.

Another example (e.g., example 4) relates to a previous example (e.g., one of the examples 1 to 3) or to any other example, further comprising that the data of the first processing circuitry is written to the physical memory for the second address space region of the address space via memory mapped I/O.

Another example (e.g., example 5) relates to a previous example (e.g., one of the examples 1 to 4) or to any other example, further comprising that the first interface identifier is an initiator of data transfer of the first processing circuitry to the second address space region of the address space using memory-mapped I/O.

Another example (e.g., example 6) relates to a previous example (e.g., one of the examples 1 to 5) or to any other example, further comprising that the application is modelled as a data flow graph comprising a plurality of nodes each to represent a respective task of the application carried out by a respective processor type.

Another example (e.g., example 7) relates to a previous example (e.g., one of the examples 1 to 6) or to any other example, further comprising that the application is modelled as a synchronous data flow, SDF, graph comprising a plurality of nodes each to represent a respective task of the application carried out by a respective processor type.

Another example (e.g., example 8) relates to a previous example (e.g., example 7) or to any other example, further comprising that the SDF graph is further comprising directed arcs connecting input ports and output ports corresponding to input and output buffers of task carried out by respective nodes, input buffers holding data tokens being read by a task and output buffers holding data tokens being generated by a task, wherein an input buffer is located in a memory identifier corresponding to a reading processing circuitry.

Another example (e.g., example 9) relates to a previous example (e.g., one of the examples 1 to 8) or to any other example, further comprising that a first task of the application is compiled on to the first processor type.

Another example (e.g., example 10) relates to a previous example (e.g., one of the examples 1 to 9) or to any other example, further comprising that the plurality of processing circuitries of the computational system comprises at least one of a central processing circuitry, CPU, micro-controller, graphical processing circuitry, GPU, digital signal processor, DSP, application-specific instruction-set processor, ASIP, accelerator, fixed function hardware, direct memory access, DMA, engine or I/O device.

Another example (e.g., example 11) relates to a previous example (e.g., one of the examples 1 to 10) or to any other example, further comprising that the interconnects for communication between the plurality of processing circuitries and the physical memory comprises at least one of a hierarchy of buses, Networks-on-Chip, point-to-point connection or ring fabric.

Another example (e.g., example 12) relates to a previous example (e.g., one of the examples 1 to 11) or to any other example, further comprising that the physical memory may comprise at least one of the static random access memory, SRAM, dynamic random access memory, DRAM, a hardware buffer, a register bank located at a specific memory-mapped address in the system, or a memory-mapped output port of the system.

Another example (e.g., example 13) relates to a previous example (e.g., one of the examples 1 to 12) or to any other example, further comprising that the first processing circuitry is writing to an address space region of the address space reachable by the first interface

Another example (e.g., example 14) relates to a previous example (e.g., one of the examples 1 to 13) or to any other example, further comprising that the processing circuitry is to execute the machine-readable instructions to generate a task interface data structure for a first task of the application comprising determining a processing circuitry identifier for a processing circuitry of the plurality of processing circuitries which executes the task, determining a memory identifier for an address space region of the address space to store input data received by input ports of the first task which is read by the determined processing circuitry during execution of the first task, determining an interface identifier for an interface of the determined processing circuitry through which data of the output ports of the first task executed by the determined processing circuitry is written to an address space region of the address space.

Another example (e.g., example 15) relates to a previous example (e.g., one of the examples 1 to 14) or to any other example, further comprising that the computational system comprising a plurality of processing circuitries is a multi-core system comprising a plurality of cores.

Another example (e.g., example 16) relates to a previous example (e.g., one of the examples 1 to 15) or to any other example, further comprising that the computational system is a system on chip.

Another example (e.g., example 17) relates to a previous example (e.g., one of the examples 1 to 16) or to any other example, further comprising that the computational system is executing digital signal processing.

An example (e.g., example 18) relates to an apparatus comprising processor circuitry configured to generate a model modelling a computational system for distributed computation of tasks of an application, the model comprising one or more processor types, wherein the computational system comprises a plurality of processing circuitries, physical memory and a respective memory address space, and one or more interconnects for communication between the plurality of processing circuitries and the physical memory, wherein a processor type includes a processing circuitry identifier, a memory identifier, and an interface identifier, and to generate a first processor type comprises providing a first processing circuitry identifier for a first processing circuitry, providing a first memory identifier for a first address space region of the address space, the first address space region being an address space from which input data is read by the first processing circuitry during task execution, providing a first interface identifier for an interface of the first processing circuitry through which data of the first processing circuitry is written to a second address space region

An example (e.g., example 19) relates to a device comprising means for processing for generating a model modelling a computational system for distributed computation of tasks of an application, the model comprising one or more processor types, wherein the computational system comprises a plurality of processing circuitries, physical memory and a respective memory address space, and one or more interconnects for communication between the plurality of processing circuitries and the physical memory, wherein a processor type includes a processing circuitry identifier, a memory identifier, and an interface identifier, and to generate a first processor type comprises providing a first processing circuitry identifier for a first processing circuitry, providing a first memory identifier for a first address space region of the address space, the first address space region being an address space from which input data is read by the first processing circuitry during task execution, providing a first interface identifier for an interface of the first processing circuitry through which data of the first processing circuitry is written to a second address space region.

An example (e.g., example 20) relates to a method comprising generating a model modelling a computational system for distributed computation of tasks of an application, the model comprising one or more processor types, wherein the computational system comprises a plurality of processing circuitries, physical memory and a respective memory address space, and one or more interconnects for communication between the plurality of processing circuitries and the physical memory, wherein a processor type includes a processing circuitry identifier, a memory identifier, and an interface identifier, and to generate a first processor type comprises providing a first processing circuitry identifier for a first processing circuitry, providing a first memory identifier for a first address space region of the address space, the first address space region being an address space from which input data is read by the first processing circuitry during task execution, providing a first interface identifier for an interface of the first processing circuitry through which data of the first processing circuitry is written to a second address space region.

Another example (e.g., example 21) relates to a previous example (e.g., example 20) or to any other example, further comprising that the method comprises generating for the first interface identifier one or more interconnect identifiers for the interconnects for communication through which data is written from the interface of the first processing circuitry to address space regions for one or more memory identifiers in one or more processor types for one or more processing circuitries of the computational system.

Another example (e.g., example 22) relates to a previous example (e.g., one of the examples 20 to 21) or to any other example, further comprising that the method comprises generating a second processor type including a second processing circuitry identifier for a second processing circuitry of the plurality of processing circuitries, generating a second memory identifier for the second address space region of the address space, the second address space region being an address space from which input data is read by the second processing circuitry during task execution, generating a second interface identifier for an interface of the second processing circuitry through which data of the second processing circuitry is written to a third address space region of the address space, wherein the second address space region in the address space to which data of the first processing circuitry is written is corresponding to the second memory identifier.

Another example (e.g., example 23) relates to a previous example (e.g., one of the examples 20 to 22) or to any other example, further comprising that the data of the first processing circuitry is written to the physical memory for the second address space region of the address space via memory mapped I/O.

Another example (e.g., example 24) relates to a previous example (e.g., one of the examples 20 to 23) or to any other example, further comprising that the first interface identifier is an initiator of data transfer of the first processing circuitry to the second address space region of the address space using memory-mapped I/O.

Another example (e.g., example 25) relates to a previous example (e.g., one of the examples 20 to 24) or to any other example, further comprising that the application is modelled as a data flow graph comprising a plurality of nodes each to represent a respective task of the application carried out by a respective processor type.

Another example (e.g., example 26) relates to a previous example (e.g., one of the examples 20 to 25) or to any other example, further comprising that the application is modelled as a synchronous data flow, SDF, graph comprising a plurality of nodes each to represent a respective task of the application carried out by a respective processor type.

Another example (e.g., example 27) relates to a previous example (e.g., example 26) or to any other example, further comprising that the SDF graph is further comprising directed arcs connecting input ports and output ports corresponding to input and output buffers of task carried out by respective nodes, input buffers holding data tokens being read by a task and output buffers holding data tokens being generated by a task, wherein an input buffer is located in a memory identifier corresponding to a reading processing circuitry.

Another example (e.g., example 28) relates to a previous example (e.g., one of the examples 20 to 27) or to any other example, further comprising that a first task of the application is compiled on to the first processor type.

Another example (e.g., example 29) relates to a previous example (e.g., one of the examples 20 to 28) or to any other example, further comprising that the plurality of processing circuitries of the computational system comprises at least one of a central processing circuitry, CPU, micro-controller, graphical processing circuitry, GPU, digital signal processor, DSP, application-specific instruction-set processor, ASIP, accelerator, fixed function hardware, direct memory access, DMA, engine or I/O device.

Another example (e.g., example 30) relates to a previous example (e.g., one of the examples 20 to 29) or to any other example, further comprising that the interconnects for communication between the plurality of processing circuitries and the physical memory comprises at least one of a hierarchy of buses, Networks-on-Chip, point-to-point connection or ring fabric.

Another example (e.g., example 31) relates to a previous example (e.g., one of the examples 20 to 30) or to any other example, further comprising that the physical memory may comprise at least one of the static random access memory, SRAM, dynamic random access memory, DRAM, a hardware buffer, a register bank located at a specific memory-mapped address in the system, or a memory-mapped output port of the system.

Another example (e.g., example 32) relates to a previous example (e.g., one of the examples 20 to 31) or to any other example, further comprising that the first processing circuitry is writing to an address space region of the address space reachable by the first interface

Another example (e.g., example 33) relates to a previous example (e.g., one of the examples 20 to 22) or to any other example, further comprising that the method comprises generating a task interface data structure for a first task of the application comprising determining a processing circuitry identifier for a processing circuitry of the plurality of processing circuitries which executes the task, determining a memory identifier for an address space region of the address space to store input data received by input ports of the first task which is read by the determined processing circuitry during execution of the first task, determining an interface identifier for an interface of the determined processing circuitry through which data of the output ports of the first task executed by the determined processing circuitry is written to an address space region of the address space.

Another example (e.g., example 34) relates to a non-transitory machine-readable storage medium including program code, when executed, to cause a machine to perform the method of any one of examples 20 to 33.

Another example (e.g., example 35) relates to a computer program having a program code for performing the method of examples 20 to 33 when the computer program is executed on a computer, a processor, or a programmable hardware component.

Another example (e.g., example 36) relates to machine-readable storage including machine readable instructions, when executed, to implement a method or realize an apparatus as described in any pending example.

An example (e.g., example 37) relates to a computational system, comprising the apparatus or the device according to any of examples 1 to 17 or 20 to 33, and the plurality of processing circuitries comprising the first processing circuitry, and the physical memory and the respective memory address space, and the one or more interconnects for communication between the plurality of processing circuitries and the physical memory, wherein a processor type includes the first processing circuitry identifier for the first processing circuitry, the first memory identifier for a first address space region of the address space and the first interface identifier for an interface of the first processing circuitry through which data of the first processing circuitry is written to a second address space region.

Another example (e.g., example 38) relates to a computational system being configured to perform the method of any one of the examples 20 to 33.

An example (e.g., example 39) relates to an apparatus comprising interface circuitry, machine-readable instructions, and processing circuitry to execute the machine-readable instructions to control a processing circuitry of a computational system including a plurality of processing circuitries to determine if a number of input data token or tokens is available at one or more input buffers of a memory space, and control the processing circuitry to determine if at least a portion of the memory space for a number of output data token or tokens is available at one or more output buffers assigned to the processing circuitry, and if it is determined that the number of input data token or tokens and memory space for the number of output data token or tokens are available, then control the processing circuitry to execute an iteration of a first task of an application, the application being modelled by a model, comprising one or more nodes representing tasks of the application executed by a respective processing circuitry of the computational system, and connections connecting a respective input port or ports representing input buffers assigned to a respective processing circuitry to execute a task represented by a particular node and a respective output port or ports representing output buffers assigned to the respective processing circuitry to execute the task represented by the particular node.

Another example (e.g., example 40) relates to a previous example (e.g., example 39) or to any other example, further comprising that the one more input buffers assigned to the respective processing circuitry to carry out the task represented by the node are storing input data tokens being read by the task and the one or more output buffers assigned to the respective processing circuitry to carry out the task represented by the node are storing output data tokens being generated by the task.

Another example (e.g., example 41) relates to a previous example (e.g., one of the examples 39 to 40) or to any other example, further comprising that an input port and an output port connected by an arc represent a memory space serving as output buffer for one of the processing circuitries and input buffer for another one of the processing circuitries.

Another example (e.g., example 42) relates to a previous example (e.g., one of the examples 39 to 41) or to any other example, further comprising that the processing circuitry is to execute the machine-readable instructions to write output data tokens to the one or more output buffers corresponding to the processing circuitry after the executing of an iteration of the first task.

Another example (e.g., example 43) relates to a previous example (e.g., one of the examples 39 to 42) or to any other example, further comprising that the processing circuitry is to execute the machine-readable instructions to read input data tokens from the one or more input buffers assigned to the processing circuitry when executing the first task.

Another example (e.g., example 44) relates to a previous example (e.g., one of the examples 49 to 43) or to any other example, further comprising that the processing circuitry is to execute the machine-readable instructions to track available space for output data tokens in one or more output buffers of the processing circuitry corresponding to one or more input buffers of further processing circuitries in the computational system based on a put indicator for each of the buffers.

Another example (e.g., example 45) relates to a previous example (e.g., example 44) or to any other example, further comprising that the processing circuitry is to execute the machine-readable instructions to update the put indicators for each of the one or more output buffers after execution of the first task based on a production rate of a corresponding output port of the first task.

Another example (e.g., example 46) relates to a previous example (e.g., one of the examples 49 to 45) or to any other example, further comprising that the processing circuitry is to execute the machine-readable instructions to track the number of available input data tokens in the one or more input buffers assigned to the processing circuitry based on a get indicator for each of the one or more input buffers.

Another example (e.g., example 47) relates to a previous example (e.g., example 46) or to any other example, further comprising that the processing circuitry is to execute the machine-readable instructions to update the get indicators for each of the one or more input buffers after execution of the first task based on a consumption rate of a corresponding input port of the first task.

Another example (e.g., example 48) relates to a previous example (e.g., example 43) or to any other example, further comprising that the processing circuitry is to execute the machine-readable instructions to share the updated put indicators for each of the one or more output buffers with the corresponding one or more input buffers connected by respective arcs.

Another example (e.g., example 49) relates to a previous example (e.g., example 47) or to any other example, further comprising that the processing circuitry is to execute the machine-readable instructions to share updated get indicators for each of the one or more input buffers with the corresponding one or more output buffers connected by respective arcs.

Another example (e.g., example 50) relates to a previous example (e.g., one of the examples 39 to 49) or to any other example, further comprising that the processing circuitry is to execute the machine-readable instructions to track the number of available input data tokens in a buffer with a get indicator and track the available space for output data tokens in the buffer with a put indicator, wherein the buffer is corresponding to an arc, representing a corresponding input buffer and output buffer.

Another example (e.g., example 51) relates to a previous example (e.g., one of the examples 1 to 50) or to any other example, further comprising that the memory space is associated with an address space region from which the input data tokens are read by the processing circuitry.

Another example (e.g., example 52) relates to a previous example (e.g., one of the examples 39 to 51) or to any other example, further comprising that the model is a synchronous data flow, SDF, graph.

Another example (e.g., example 53) relates to a previous example (e.g., one of the examples 39 to 52) or to any other example, further comprising that the application is modeled by one or more directed graphs.

Another example (e.g., example 54) relates to a previous example (e.g., one of the examples 39 to 53) or to any other example, further comprising that the buffers are FIFO modulo buffers.

Another example (e.g., example 55) relates to a previous example (e.g., one of the examples 39 to 54) or to any other example, further comprising that the computational system is a system on chip.

Another example (e.g., example 56) relates to a previous example (e.g., one of the examples 39 to 55) or to any other example, further comprising that the computational system is targeting digital signal processing.

An example (e.g., example 57) relates to an apparatus comprising processor circuitry configured to control a processing circuitry of a computational system including a plurality of processing circuitries to determine if a number of input data token or tokens is available at one or more input buffers of a memory space, and control the processing circuitry to determine if at least a portion of the memory space for a number of output data token or tokens is available at one or more output buffers assigned to the processing circuitry, and if it is determined that the number of input data token or tokens and memory space for the number of output data token or tokens are available, then control the processing circuitry to execute an iteration of a first task of an application, the application being modelled by a model, comprising one or more nodes representing tasks of the application executed by a respective processing circuitry of the computational system, and connections connecting a respective input port or ports representing input buffers assigned to a respective processing circuitry to execute a task represented by a particular node and a respective output port or ports representing output buffers assigned to the respective processing circuitry to execute the task represented by the particular node.

An example (e.g., example 58) relates to a device comprising means for processing for controlling a processing circuitry of a computational system including a plurality of processing circuitries to determine if a number of input data token or tokens is available at one or more input buffers of a memory space, and controlling the processing circuitry to determine if at least a portion of the memory space for a number of output data token or tokens is available at one or more output buffers assigned to the processing circuitry, and if it is determined that the number of input data token or tokens and memory space for the number of output data token or tokens are available, then controlling the processing circuitry to execute an iteration of a first task of an application, the application being modelled by a model, comprising one or more nodes representing tasks of the application executed by a respective processing circuitry of the computational system, and connections connecting a respective input port or ports representing input buffers assigned to a respective processing circuitry to execute a task represented by a particular node and a respective output port or ports representing output buffers assigned to the respective processing circuitry to execute the task represented by the particular node.

An example (e.g., example 59) relates to a method comprising controlling a processing circuitry of a computational system including a plurality of processing circuitries to determine if a number of input data token or tokens is available at one or more input buffers of a memory space, and controlling the processing circuitry to determine if at least a portion of the memory space for a number of output data token or tokens is available at one or more output buffers assigned to the processing circuitry, and if it is determined that the number of input data token or tokens and memory space for the number of output data token or tokens are available, then controlling the processing circuitry to execute an iteration of a first task of an application, the application being modelled by a model, comprising one or more nodes representing tasks of the application executed by a respective processing circuitry of the computational system, and connections connecting a respective input port or ports representing input buffers assigned to a respective processing circuitry to execute a task represented by a particular node and a respective output port or ports representing output buffers assigned to the respective processing circuitry to execute the task represented by the particular node.

Another example (e.g., example 60) relates to a previous example (e.g., example 59) or to any other example, further comprising that the one more input buffers assigned to the respective processing circuitry to carry out the task represented by the node are storing input data tokens being read by the task and the one or more output buffers assigned to the respective processing circuitry to carry out the task represented by the node are storing output data tokens being generated by the task.

Another example (e.g., example 61) relates to a previous example (e.g., one of the examples 59 to 60) or to any other example, further comprising that an input port and an output port connected by an arc represent a memory space serving as output buffer for one of the processing circuitries and input buffer for another one of the processing circuitries.

Another example (e.g., example 62) relates to a previous example (e.g., one of the examples 59 to 61) or to any other example, further comprising that the method comprises writing output data tokens to the one or more output buffers corresponding to the processing circuitry after the executing of an iteration of the first task.

Another example (e.g., example 63) relates to a previous example (e.g., one of the examples 59 to 62) or to any other example, further comprising that the method comprises to reading input data tokens from the one or more input buffers assigned to the processing circuitry when executing the first task.

Another example (e.g., example 64) relates to a previous example (e.g., one of the examples 59 to 63) or to any other example, further comprising that the method comprises tracking available space for output data tokens in one or more output buffers of the processing circuitry corresponding to one or more input buffers of further processing circuitries in the computational system based on a put indicator for each of the buffers.

Another example (e.g., example 65) relates to a previous example (e.g., example 64) or to any other example, further comprising that the method comprises updating the put indicators for each of the one or more output buffers after execution of the first task based on a production rate of a corresponding output port of the first task.

Another example (e.g., example 66) relates to a previous example (e.g., one of the examples 59 to 65) or to any other example, further comprising that the method comprises tracking the number of available input data tokens in the one or more input buffers assigned to the processing circuitry based on a get indicator for each of the one or more input buffers.

Another example (e.g., example 66) relates to a previous example (e.g., example 66) or to any other example, further comprising that the method comprises updating the get indicators for each of the one or more input buffers after execution of the first task based on a consumption rate of a corresponding input port of the first task.

Another example (e.g., example 67) relates to a previous example (e.g., example 63) or to any other example, further comprising that the method comprises sharing the updated put indicators for each of the one or more output buffers with the corresponding one or more input buffers connected by respective arcs.

Another example (e.g., example 68) relates to a previous example (e.g., example 66) or to any other example, further comprising that the method comprises sharing updated get indicators for each of the one or more input buffers with the corresponding one or more output buffers connected by respective arcs.

Another example (e.g., example 69) relates to a previous example (e.g., one of the examples 59 to 68) or to any other example, further comprising that the method comprises tracking the number of available input data tokens in a buffer with a get indicator and track the available space for output data tokens in the buffer with a put indicator, wherein the buffer is corresponding to an arc, representing a corresponding input buffer and output buffer.

Another example (e.g., example 70) relates to a non-transitory machine-readable storage medium including program code, when executed, to cause a machine to perform the method of any one of the examples 59 to 69.

Another example (e.g., example 71) relates to a computer program having a program code for performing the method of examples 59 to 69 when the computer program is executed on a computer, a processor, or a programmable hardware component.

Another example (e.g., example 72) relates to a machine-readable storage including machine readable instructions, when executed, to implement a method or realize an apparatus as described in any pending example.

An example (e.g., example 73) relates to a computational system, comprising a plurality of processing circuitries, and wherein a first processing circuitry of the plurality of processing circuitries of the computational system is configured to determine if a number of input data token or tokens is available at one or more input buffers of the memory space assigned to the first processing circuitry, and determine if at least a portion of the memory space for a number of output data token or tokens is available at one or more output buffers assigned to the first processing circuitry, and if it is determined that the number of input data token or tokens and that memory space for the number of output data token or tokens are available, then the first processing circuitry is configured to execute an iteration of a first task of an application, the application being modelled by a model, comprising one or more nodes representing tasks of the application executed by a respective processing circuitry of the computational system, and connections connecting a respective input port or ports representing input buffers assigned to a respective processing circuitry to execute a task represented by a particular node and a respective output port or ports representing output buffers assigned to the respective processing circuitry to execute the task represented by the particular node.

Another example (e.g., example 74) relates to wherein the second processing circuitry of the plurality of processing circuitries of the computational system is configured to determine if a number of input data token or tokens is available at one or more input buffers of the memory space assigned to the second processing circuitry, and determine if at least a portion of the memory space for a number of output data token or tokens is available at one or more output buffers assigned to the second processing circuitry, and if it is determined that the number of input data token or tokens and that memory space for the number of output data token or tokens are available, then the second processing circuitry is configured to execute an iteration of a second task of the application.

Another example (e.g., example 75) relates to a computational system being configured to perform the method of one of the examples 59 to 69.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processing circuitry to execute the machine-readable instructions to:
control a processing circuitry of a computational system including a plurality of processing circuitries to determine if a number of input data token or tokens is available at one or more input buffers of a memory space; and
control the processing circuitry to determine if at least a portion of the memory space for a number of output data token or tokens is available at one or more output buffers assigned to the processing circuitry; and
if it is determined that the number of input data token or tokens and memory space for the number of output data token or tokens are available, then control the processing circuitry to execute an iteration of a first task of an application, the application being modelled by a model, comprising:
one or more nodes representing tasks of the application executed by a respective processing circuitry of the computational system; and
connections connecting a respective input port or ports representing input buffers assigned to a respective processing circuitry to execute a task represented by a particular node and a respective output port or ports representing output buffers assigned to the respective processing circuitry to execute the task represented by the particular node.

2. The apparatus according to claim 1, wherein the one more input buffers assigned to the respective processing circuitry to carry out the task represented by the node are storing input data tokens being read by the task and the one or more output buffers assigned to the respective processing circuitry to carry out the task represented by the node are storing output data tokens being generated by the task.

3. The apparatus according to claim 1, wherein an input port and an output port connected by an arc represent a memory space serving as output buffer for one of the processing circuitries and input buffer for another one of the processing circuitries.

4. The apparatus according to claim 1, wherein the processing circuitry is to execute the machine-readable instructions to write output data tokens to the one or more output buffers corresponding to the processing circuitry after the executing of an iteration of the first task.

5. The apparatus according to claim 1, wherein the processing circuitry is to execute the machine-readable instructions to read input data tokens from the one or more input buffers assigned to the processing circuitry when executing the first task.

6. The apparatus according to claim 1, wherein the processing circuitry is to execute the machine-readable instructions to track available space for output data tokens in one or more output buffers of the processing circuitry corresponding to one or more input buffers of further processing circuitries in the computational system based on a put indicator for each of the buffers.

7. The apparatus according to claim 6, wherein the processing circuitry is to execute the machine-readable instructions to update the put indicators for each of the one or more output buffers after execution of the first task based on a production rate of a corresponding output port of the first task.

8. The apparatus according to claim 1, wherein the processing circuitry is to execute the machine-readable instructions to track the number of available input data tokens in the one or more input buffers assigned to the processing circuitry based on a get indicator for each of the one or more input buffers.

9. The apparatus according to claim 8, wherein the processing circuitry is to execute the machine-readable instructions to update the get indicators for each of the one or more input buffers after execution of the first task based on a consumption rate of a corresponding input port of the first task.

10. The apparatus according to claim 5, wherein the processing circuitry is to execute the machine-readable instructions to share the updated put indicators for each of the one or more output buffers with the corresponding one or more input buffers connected by respective arcs.

11. The apparatus according to claim 9, wherein the processing circuitry is to execute the machine-readable instructions to share updated get indicators for each of the one or more input buffers with the corresponding one or more output buffers connected by respective arcs.

12. The apparatus according to according to claim 1, wherein the processing circuitry is to execute the machine-readable instructions to track the number of available input data tokens in a buffer with a get indicator and track the available space for output data tokens in the buffer with a put indicator, wherein the buffer is corresponding to an arc, representing a corresponding input buffer and output buffer.

13. The apparatus according to claim 12, wherein the memory space is associated with an address space region from which the input data tokens are read by the processing circuitry.

14. The apparatus according to claim 1, wherein the model is a synchronous data flow, SDF, graph.

15. The apparatus according to claim 1, wherein the application is modeled by one or more directed graphs.

16. The apparatus according to claim 1, wherein the buffers are FIFO modulo buffers.

17. The apparatus according to claim 1, wherein the computational system is a system on chip, SoC.

18. The apparatus according to claim 1, wherein the computational system is targeting digital signal processing.

19. A method comprising:
controlling a processing circuitry of a computational system including a plurality of processing circuitries to determine if a number of input data token or tokens is available at one or more input buffers of a memory space; and
controlling the processing circuitry to determine if at least a portion of the memory space for a number of output data token or tokens is available at one or more output buffers assigned to the processing circuitry; and
if it is determined that the number of input data token or tokens and memory space for the number of output data token or tokens are available, then controlling the processing circuitry to execute an iteration of a first task of an application, the application being modelled by a model, comprising:
one or more nodes representing tasks of the application executed by a respective processing circuitry of the computational system; and connections connecting a respective input port or ports representing input buffers assigned to a respective processing circuitry to execute a task represented by a particular node and a respective output port or ports representing output buffers assigned to the respective processing circuitry to execute the task represented by the particular node.

20. A computational system, comprising:
a plurality of processing circuitries; and
wherein a first processing circuitry of the plurality of processing circuitries of the computational system is configured to:
determine if a number of input data token or tokens is available at one or more input buffers of the memory space assigned to the first processing circuitry; and
determine if at least a portion of the memory space for a number of output data token or tokens is available at one or more output buffers assigned to the first processing circuitry; and
if it is determined that the number of input data token or tokens and that memory space for the number of output data token or tokens are available, then the first processing circuitry is configured to execute an iteration of a first task of an application, the application being modelled by a model, comprising:
one or more nodes representing tasks of the application executed by a respective processing circuitry of the computational system; and connections connecting a respective input port or ports representing input buffers assigned to a respective processing circuitry to execute a task represented by a particular node and a respective output port or ports representing output buffers assigned to the respective processing circuitry to execute the task represented by the particular node.
